(19) United States
(12) Patent Application Publication
(10) Pub. No.: US 2006/0025204 A1
(43) Pub. Date: Feb. 2, 2006

(54) Gaming machine

(76) Inventor: Kazuo Okada, Tokyo (JP)

Correspondence Address: ARENT FOX PLLC, 1050 CONNECTICUT AVENUE, N.W., SUITE 400, WASHINGTON, DC, 20036, US

(21) Appl. No.: 11/186,936

(22) Filed: Jul. 22, 2005

(30) Foreign Application Priority Data
Jul. 27, 2004 (JP) 2004-218455
Aug. 24, 2004 (JP) 2004-243259

(51) Int. Cl. A63F 13/00

(52) U.S. Cl. 463/20

(57) ABSTRACT

On each of the variable display portions 21 to 25 in the slot machine 1, when the symbols are stopped and displayed, at first the symbols are displayed in the state shown in the uppermost display example of FIG. 1, thereafter the symbol “A” is displayed instead of the symbol “WILD” stopped and displayed on the pay line as shown in the second display example of FIG. 1. Further, thereafter, as shown in the third display example, the symbol “J” is displayed instead of the symbol “A”. Thereafter, as shown in the lowermost display example of FIG. 1, the symbol “WILD” is displayed instead of the symbol “J”, thereby the symbols are returned to the state when first stopped and displayed.

### CROSS-REFERENCE TO THE RELATED APPLICATIONS (S)

This application is based upon and claims a priority from the prior Japanese Patent Application Nos. 2004-218455 filed on Jul. 27, 2004 and 2004-243259 filed on Aug. 24, 2004, the entire contents of which are incorporated herein by reference.

### BACKGROUND OF THE INVENTION

1. Field of the Invention

The present invention relates to a gaming machine in which a game is conducted by utilizing symbols variably displayed and stopped.

2. Description of Related Art

In a conventional gaming machine, for example, a slot machine, in a case that a symbol combination displayed at a stop state of a plurality of reels corresponds to any one of winning symbol combinations after the reels are rotated for a predetermined time, coins and the like corresponding to the winning symbol combination are paid out.

Here, as for symbol combinations, although it is general that the symbol combinations are constructed only from normal symbols which are handled as such symbols themselves, there will be a case that the symbol combinations are constructed from symbols including an almighty symbol (hereinafter, called as “wild symbol”) which can be regarded as any one of the normal symbols, as shown in Unexamined Japanese Publication No. 2002-320713.

Therefore, in a case that the symbol combination including the “wild symbol” is stopped and displayed, if this symbol combination corresponds to any of the winning symbol combinations by regarding the “wild symbol” as any one of the normal symbols, coins corresponding to the winning symbol combination are paid out in spite that such symbol combination does not directly coincide with the winning symbol combination. Therefore, in this case, fortunate feelings can be given to a player.

However, as mentioned, since the above symbol combination does not directly coincide with the winning symbol combination, when the symbol combination is stopped and displayed, there is tendency that it is hard for the player to recognize at sight that the symbol combination corresponds to which winning symbol combination.

In particular, in a case that the symbol combination is validated every an activated pay line based on symbols stopped and displayed on a plurality of pay lines which are activated, there will be a case that the “wild symbol” stopped and displayed on plural activated pay lines can be regarded as plural kinds of symbols. Thus, in this case, above tendency becomes remarkable.

### SUMMARY OF THE INVENTION

Therefore, in order to dissolve the above problems, the present invention has been done and has an object to provide a gaming machine in which a player can recognize at sight a winning symbol combination to which a symbol combination including a wild symbol corresponds right after the symbol combination is stopped and displayed.

In order to accomplish the above object, according to one aspect of the present invention, it is provided a gaming machine comprising:
a display device for displaying plural kinds of symbols including a wild symbol which is substitutable for one of the symbols;
a first determination device for determining whether or not a symbol combination constructed from the symbols stopped on the display device corresponds to a predetermined winning symbol combination while regarding the wild symbol as one of the symbols;
a second determination device for determining whether or not the wild symbol is included in the symbol combination if it is determined by the first determination device that the symbol combination corresponds to the predetermined winning symbol combination; and
a display control device for controlling the display device so as to display the symbol combination corresponding to the predetermined winning symbol combination while substituting the wild symbol for one of the symbols if it is determined by the second determination device that the wild symbol is included in the symbol combination.

In the gaming machine according to the present invention, in a case that the wild symbol is included in the symbol combination stopped and displayed on the display device and the symbol combination corresponds to the winning symbol combination by substituting the wild symbol for one of the symbols, the symbol combination is displayed on the display device while substituting the wild symbol for one of the symbols. Therefore, the winning symbol combination can be directly displayed on the display device on the basis of the symbol combination, in which the wild symbol is substituted for one of the symbols, displayed right after the symbol combination is stopped. Therefore, the player can recognize the winning symbol combination at sight continuously after the symbol combination is stopped and displayed.

Further, according to another aspect of the present invention, it is provided a gaming machine comprising:
a plurality of reels having plural kinds of symbols thereon, at least one reel having a wild symbol which is able to be regarded as one of the symbols included in the symbols;
a display device arranged in front of the reels, the display device having a plurality of display windows each of which is able to become a transmissive state that the symbols of the reels are seen therethrough and an opaque state that the symbols are displayed thereon;
a first determination device for determining whether or not a symbol combination constructed from the symbols stopped within each of the display windows corresponds to a predetermined winning symbol combination while regarding the wild symbol as one of the symbols;
a second determination device for determining whether or not the wild symbol is included in the symbol combination if it is determined by the first determination device that the symbol combination corresponds to the predetermined winning symbol combination; and
a display control device for controlling the display device to display the symbol in the display window so that the symbol covers the wild symbol in the opaque state and the symbol combination corresponds to the predetermined winning symbol combination if it is determined by the second determination device that the wild symbol is included in the symbol combination.

According to the above gaming machine, in a case that the wild symbol is included in the symbol combination stopped within each of the display windows of the display device and the symbol combination corresponds to the winning symbol combination by regarding the wild symbol for one of the symbols, such regarded symbol is displayed in the window so that the symbol covers the wild symbol in the opaque state and the symbol combination corresponds to the predetermined winning symbol combination. Therefore, the winning symbol combination can be directly displayed on the display device on the basis of the symbol combination, in which the wild symbol is covered by the symbol, displayed right after the symbol combination is stopped within each of the display windows of the display device. Therefore, the player can recognize the winning symbol combination at sight continuously after the symbol combination is stopped and displayed.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is an explanatory view showing a substitution display example by utilizing five variable display portions in the first embodiment,

FIG. 2 is an explanatory view showing a substitution display example by utilizing five variable display portions in the first embodiment,

FIG. 3 is an explanatory view showing a deletion display example by utilizing five variable display portions in the first embodiment,

FIG. 4 is an explanatory view showing a symbol combination example stopped and displayed through five variable display portions in the first embodiment,

FIG. 5 is an explanatory view showing one winning symbol combination realized on the basis of the symbol combination shown in FIG. 4,

FIG. 6 is an explanatory view showing another winning symbol combination realized on the basis of the symbol combination shown in FIG. 4,

FIG. 7 is a flowchart of a program based on which a substitution display is conducted in the first embodiment,

FIG. 8 is a perspective view of a slot machine according to the first embodiment,

FIG. 9 is a front view of a control panel in the first embodiment,

FIG. 10 is a block diagram schematically showing a control system of the slot machine of the first embodiment,

FIG. 11 is a block diagram showing a liquid crystal drive circuit of liquid crystal displays in the first embodiment,

FIG. 12 is an explanatory view schematically showing an example of symbol columns variable displayed on variable display portions in a base game conducted in the slot machine of the first embodiment,

FIG. 13 is an explanatory view showing winning symbol combinations and payouts thereof in the first embodiment FIG. 14 is an explanatory view showing a lottery table of stop display symbols in the first embodiment,

FIG. 15 is an explanatory view showing stop display areas of five variable display portions in the first embodiment,

FIG. 16 is a flowchart of a main process program conducted in the slot machine of the first embodiment,

FIG. 17 is a flowchart of a start acceptance process program conducted in the slot machine of the first embodiment,

FIG. 18 is a flowchart of a lottery process program conducted in the slot machine of the first embodiment,

FIG. 19 is a flowchart of base game process program conducted in the slot machine of the first embodiment,

FIG. 20 is a flowchart of a bonus game process program conducted in the slot machine of the first embodiment,

FIG. 21 is an explanatory view showing a lottery table of the stop display symbols in the first embodiment,

FIG. 22 is an explanatory view schematically showing an example of symbol columns variable displayed on the variable display portions in a bonus game conducted in the slot machine of the first embodiment,

FIG. 23 is an explanatory view showing a substitution display example by utilizing three variable display portions in the second embodiment,

FIG. 24 is an explanatory view showing a substitution display example by utilizing three variable display portions in the second embodiment,

FIG. 25 is a flowchart of a base game process program conducted in the second embodiment,

FIG. 26 is an explanatory view showing pay lines in the second embodiment,

FIG. 27 is a perspective view of a slot machine according to the second embodiment,

FIG. 28 is a sectional view of a lower liquid crystal display and a reel which are vertically sectioned, in the second embodiment,

FIG. 29 is an exploded perspective view of the lower liquid crystal display in the second embodiment,

FIG. 30 is a block diagram of a control system in the slot machine of the second embodiment,

FIG. 31 is a block diagram of a liquid crystal drive circuit of the liquid crystal displays in the second embodiment,

FIG. 32 is an explanatory view schematically showing symbol columns variably displayed on variable display portions, the symbol columns being displayed on reels and able to be seen through the lower liquid crystal display in a base game,

FIG. 33 is an explanatory view schematically showing symbol columns variably displayed on the variable display portions, the symbol columns being displayed on the lower liquid crystal display in a bonus game,

FIG. 34 is an explanatory view showing a lottery table of stop display symbols when the base game is executed by utilizing three variable display portions,

FIG. 35 is an explanatory view showing winning symbol combinations and payouts thereof when the base game is executed by utilizing three variable display portions,

FIG. 36 is an explanatory view showing a lottery table of stop display symbols when the bonus game is executed by utilizing three variable display portions,

FIG. 37 is an explanatory view showing winning symbol combinations and payouts thereof when the bonus game is executed by utilizing three variable display portions,

FIG. 38 is a flowchart of a main process program conducted in the second embodiment,

FIG. 39 is a flowchart of a start acceptance process program conducted in the second embodiment,

FIG. 40 is a flowchart of a lottery process program conducted in the second embodiment,

FIG. 41 is a flowchart of a base game process program conducted in the second embodiment, and

FIG. 42 is a flowchart of a bonus process program conducted in the second embodiment.

### DETAILED DESCRIPTION OF THE PREFERRED EMBODIMENTS

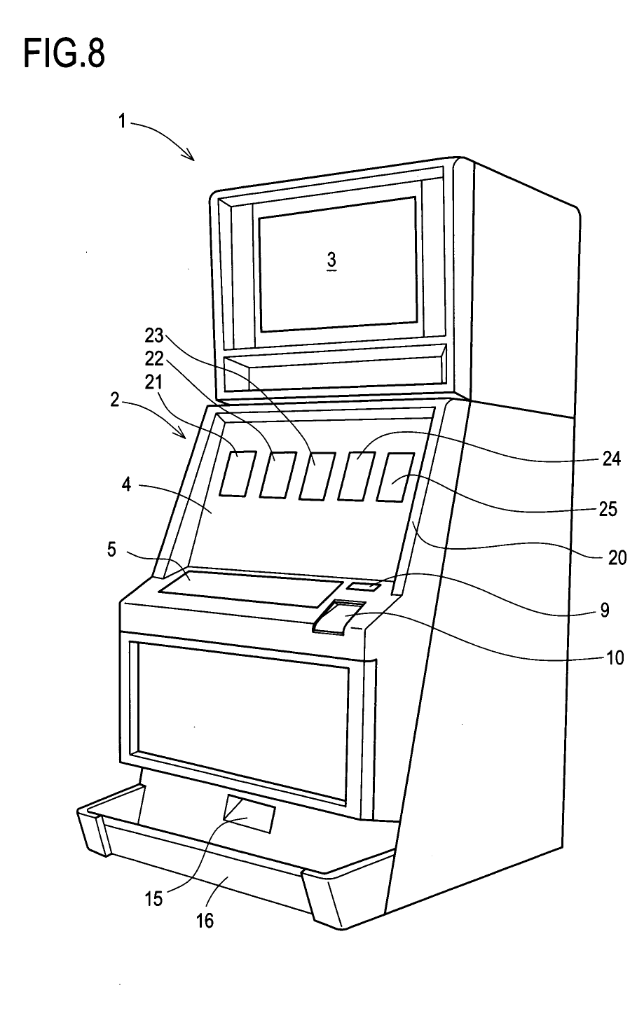

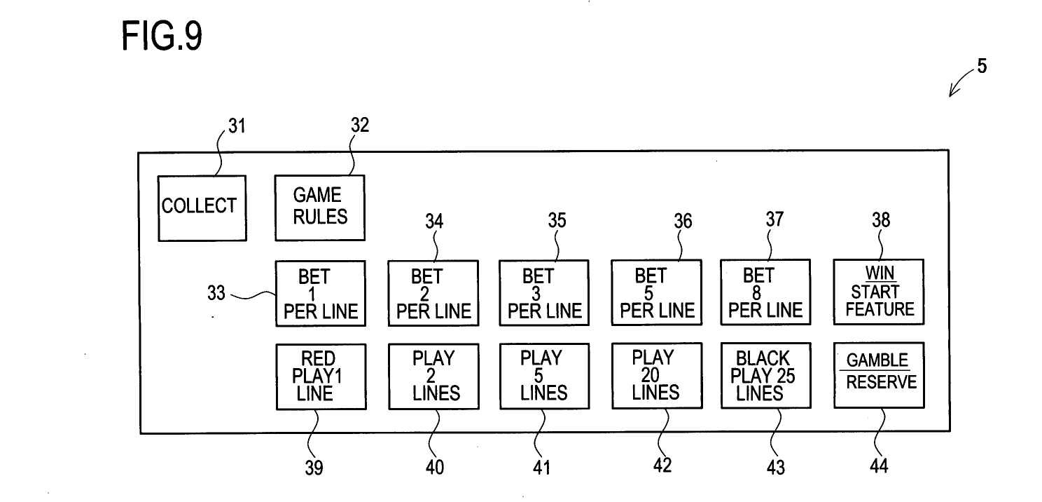

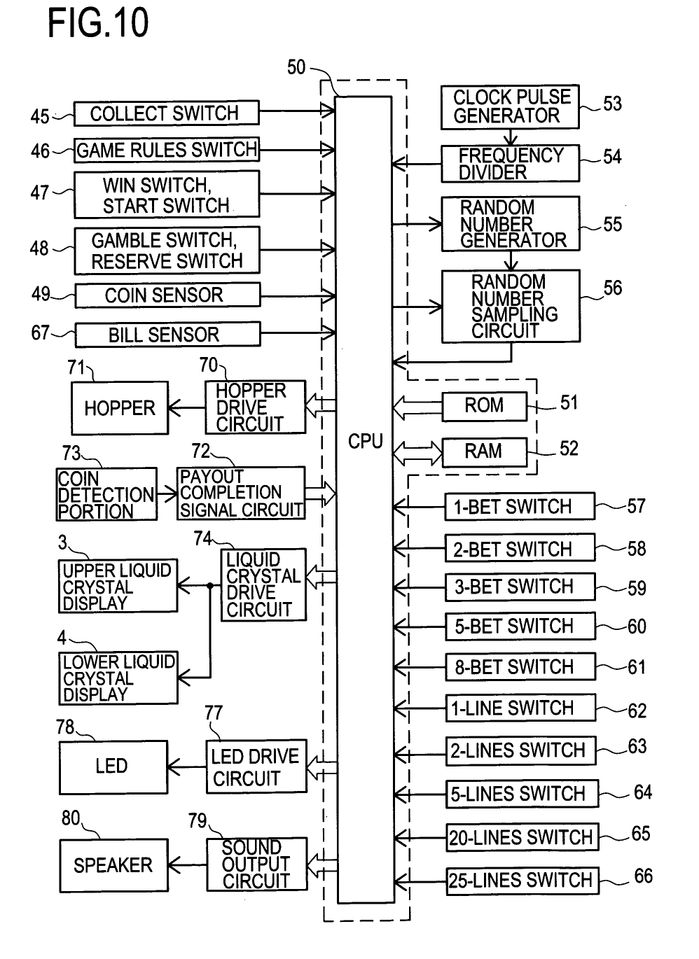

Hereinafter, concerning with a gaming machine according to the present invention, embodiments embodying the present invention in a slot machine will be described in detail with reference to the drawings. First, an outline construction of the slot machine according to the first embodiment will be described with reference to FIGS. 8 to 10. FIG. 8 is a perspective view of the slot machine. FIG. 9 is a front view of a control panel. FIG. 10 is a block diagram schematically showing a control system of the slot machine.

In FIG. 8, the slot machine 1 has a cabinet 2 which forms whole construction of the slot machine 1. At an upper position of a front plane of the cabinet 2, an upper liquid crystal display 3 is arranged and a lower liquid crystal display 4 is arranged on a device front panel 20 which is arranged at a center position of the front plane of the cabinet 2. Here, both the upper liquid crystal display 3 and the lower liquid crystal display 4 are constructed from liquid crystal display generally used. On the upper liquid crystal display 3, it is indicated information concerning with a game such as methods, kinds of winning symbol combinations and payouts corresponding thereto and various effects. And on a surface of the lower liquid crystal display 4, credits are displayed and five variable display portions 21, 22, 23, 24 and 25 are basically displayed as shown in FIG. 8. On each of the variable display portion 21, 22, 23, 24 and 25, various symbols are variably displayed while being scrolled (hereinafter, called as “scroll display”) from an upper direction toward a lower direction, thereafter stopped and displayed.

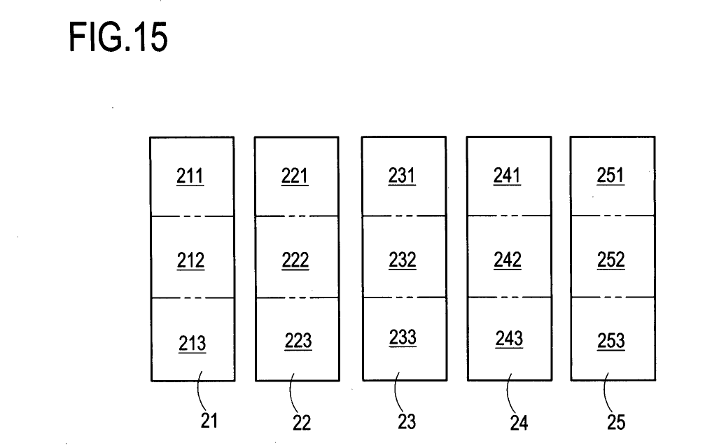

Therefore, in the slot machine 1 of the first embodiment, a slot game (there exist a base game and a bonus game) is conducted through a video reels which are realized by displaying variable display portions 21 to 25 on the lower liquid crystal display 4. In the slot game (there exist a base game and a bonus game), there exist three symbols stopped and displayed on each of the variable display portions 21 to 25. That is to say, as shown in FIG. 15, the variable display portions 21 to 25 are divided into first stop areas 211, 221, 231, 241, 251, second stop areas 212, 222, 232, 242, 252, and third stop areas 213, 223, 233, 243, 253. And the symbols are respectively stopped and displayed on the stop areas 211˜213, 221˜223, 231˜233, 241˜243, 251˜253.

And in this slot game (base game and bonus game), there exist twenty-five pay lines, each spanning five stop areas among the stop areas 211˜213, 221˜223, 231˜233, 241˜243, 251˜253. If each of the pay lines is activated and specific symbols are aligned with a specific display mode along the activated pay line when the symbols are stopped and displayed, a predetermined payout is given to the player. Here, explanation of the twenty-five pay lines will be omitted.

Here, the pay line (s) activated among the 25 pay lines is/are called as “activated pay line (s)”

Back to FIG. 8, at an lower position of the lower liquid crystal display 4, a control panel 5 which is projected forward is formed. In the control panel 5 as shown in FIG. 9, a COLLECT button 31 and a GAME RULES button 32 are arranged in an upper step from the most left side, and a BET 1 PER LINE button 33, a BET 2 PER LINE button 34, a BET 3 PER LINE button 35, a BET 5 PER LINE button 36, a BET 8 PER LINE button 37 and a WIN START FEATURE button 38 are arranged in a middle step from the most left side. Further, a RED PLAY 1 LINE button 39, a PLAY 2 LINES button 40, a PLAY 5 LINES button 41, a PLAY 20 LINES button 42, a BLACK PLAY 25 LINES button 43 and a GAMBLE RESERVE button 44 are arranged in a lower step from the most left side. And as shown in FIG. 8, at the right side of the control panel 5, a coin insertion slot 9 and a bill insertion portion 10 are provided.

Here, the COLLECT button 31 is a button which is pressed when the base game is terminated, and when the COLLECT button 31 is pressed, coins equal to the credits obtained in the game are paid out from a coin payout opening 15 to a coin tray 16. To the COLLECT button 31, a COLLECT switch 45 is attached and a switch signal is output to a CPU 50 from the COLLECT switch 45 on the basis of press of the COLLECT button 31 (see FIG. 10).

The GAME RULES button 32 is a button which is pressed if operation methods of the game cannot be understood, and when the GAME RULES button 32 is pressed, various help information is displayed on the upper liquid crystal display 3 or the lower liquid crystal display 4. To the GAME RULES button 32, a GAME RULES switch 46 is attached and a switch signal is output to the CPU 50 from the GAME RULES switch 46 on the basis of press of the GAME RULES button 32 (see FIG. 10).

To the coin insertion slot 9, a coin sensor 49 is arranged and when a coin is inserted in the coin insertion slot 9, a coin detection signal is output to the CPU 50 through the coin sensor 49 (see FIG. 10) and credit corresponding to the inserted coin is added. And to the bill insertion portion 10, a bill sensor 67 is arranged and when a bill is inserted in the bill insertion portion 10, a bill detection signal is output to the CPU 50 through the bill sensor 67 (see FIG. 10), and credit corresponding to the inserted bill is added.

The BET 1 PER LINE button 33 is a button to bet one credit to each of the activated pay lines every one press thereof. To this BET 1 PER LINE button 33, a 1-BET switch 57 is attached and when the BET 1 PER LINE button 33 is pressed, a switch signal is output to the CPU 50 from the 1-BET switch 57 (see FIG. 10). The BET 2 PER LINE button 34 is a button to start the game with 2 bets against each of the activated pay lines on the basis of press thereof. To the BET 2 PER LINE button 34, a 2-BET switch 58 is attached and when the BET 2 PER LINE button 34 is pressed, a switch signal is output to the CPU 50 from the 2-BET switch 58 (see FIG. 10).

The BET 3 PER LINE button 35 is a button to start the game wit 3 bets against each of the activated pay lines on the basis of press thereof. To the BET 3 PER LINE button 35, a 3-BET switch 59 is attached and when the BET 3 PER LINE button 35 is pressed, a switch signal is output to the CPU 50 from the 3-BET switch 59 (see FIG. 10). And the BET 5 PER LINE button 36 is a button to start the game with 5 bets against each of the activated pay lines on the basis of press thereof. To the BET 5 PER LINE button 36, a 5-BET switch 60 is attached and when the BET 5 PER LINE button 36 is pressed, a switch signal is output to the CPU from the 5-BET switch 60 (see FIG. 10).

The BET 8 PER LINE button 37 is a button to start the game with 8 bets against each of the activated pay lines on the basis of press thereof. To the BET 8 PER LINE button 37, a 8-BET switch 61 is attached and when the BET 8 PER LINE switch 37 is pressed, a switch signal is output to the CPU 50 from the 8-BET switch 61 (see FIG. 10). Therefore, there will exist 1 bet, 2 bets, 3 bets, 5 bets and 8 bets as the bet number which can be betted by press of the BET 1 PER LINE button 33, the BET 2 PER LINE button 34, the BET 3 PER LINE button 35, the BET 5 PER LINE button 36 and the BET 8 PER LINE button 37.

The WIN START FEATURE button 38 is a button to start a bonus game or add the payout obtained in the bonus game to the credit on the basis of press thereof. To the WIN START FEATURE button 38, a WIN START switch 47 is attached and when the WIN START FEATURE button 38 is pressed, a switch signal is output to the CPU 50 from the WIN START switch 47 (see FIG. 10).

The RED PLAY 1 LINE button 39 is a button to start the game while retaining the number of the activated pay line to “1” on the basis of press thereof. To the RED PLAY 1 LINE button 39, a 1-LINE switch 62 is attached and when the RED PLAY 1 LINE button 39 is pressed, a switch signal is output to the CPU 50 from the 1-LINE switch 62 (see FIG. 10). And the PLAY 2 LINES button 40 is a button to start the game while retaining the number of the activated pay line to “2” on the basis of press thereof. To the PLAY 2 LINES button 49, a 2-LINES switch 63 is attached and when the PLAY 2 LINES button 40 is pressed, a switch signal is output to the CPU 50 from the 2-LINES switch 63 (see FIG. 10).

The PLAY 5 LINES button 41 is a button to start the game while retaining the number of the activated pay line to “5” on the basis of press thereof. To the PLAY 5 LINES button 41, a 5-LINES switch 64 is attached and when the PLAY 5 LINES button 41 is pressed, a switch signal is output to the CPU 50 from the 5-LINES switch 64 (see FIG. 10). And the PLAY 20 LINES button 42 is a button to start the game while retaining the number of the activated pay line to “20” on the basis of press thereof. To the PLAY 20 LINES button 42, a 20-LINES switch 65 is attached and when the PLAY 20 LINES button 42 is pressed, a switch signal is output to the CPU 50 from the 20-LINES switch 65 (see FIG. 10).

The BLACK PLAY 25 LINES button 43 is a button to start the game while retaining the number of the activated pay line to “25” on the basis of press thereof. To the BLACK PLAY 25 LINES button 43, a 25-LINES switch 66 is attached and when the BLACK PLAY 25 LINES button 43 is pressed, a switch signal is output to the CPU 50 from the 25-LINES switch 66 (see FIG. 10).

Therefore, there will exist “1” pay line, “2” pay lines, “5” pay lines, “20” pay lines and “25” pay lines as the number of the activated pay lines which can be determined by press of the RED PLAY 1 LINE button 39, the PLAY 2 LINES button 49, the PLAY 5 LINES button 41, the PLAY 20 LINES button 42, the BLACK PLAY 25 LINES button 43.

And each of the RED PLAY 1 LINE button 39, the PLAY 2 LINES button 49, the PLAY 5 LINES button 41, the PLAY 20 LINES button 42 and the BLACK PLAY 25 LINES button 43 is a button to start the game with the present bet number and the number of the activated pay lines and to start variable display of the symbols on each of the variable display portions 21 to 25 in the lower liquid crystal display 4.

Here, the RED PLAY 1 LINE button 39 and the BLACK PLAY 25 LINES button 43 are also used for selecting red or black in the double down game which is conducted by using the credit obtained in the bonus game.

The GAMBLE RESERVE button 44 is a button to be pressed when the player leaves the seat and to shift to the double down game after the bonus game is terminated. To the GAMBLE RESERVE button 44, a GAMBLE•RESERVE switch 48 is attached and when the GAMBLE RESERVE button 44 is pressed, a switch signal is output to the CPU 50 from the GAMBLE•RESERVE switch 48 (see FIG. 10).

And at a lower position of the cabinet 2, a coin payout opening 15 is formed and a coin tray 16 for receiving coins paid out from the coin payout opening 15 is provided. Within the coin payout opening 15 it is arranged a coin detection portion 73 (mentioned later) which is constructed from sensors and the like (see FIG. 10). And the coin detection portion 73 counts the number of coins paid out from the coin payout opening 15.

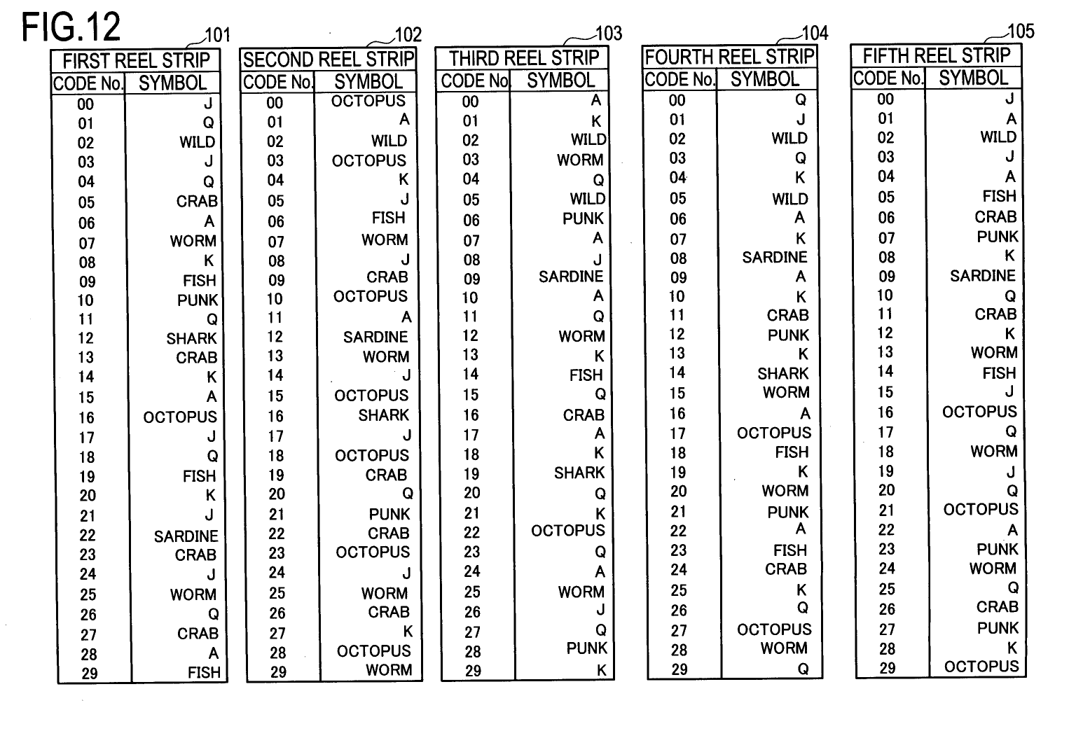

Next, with reference to FIG. 12, it will be described the symbol columns which are variably displayed while being scrolled on each of the variable display portions 21 to 25, the symbol columns being displayed on the lower liquid crystal display 4 in the base game. In FIG. 12, the symbol column indicated by a first reel strip 101 corresponds to a symbol column variably displayed on the variable display portion 21, the symbol column indicated by a second reel strip 102 corresponds to a symbol column variably displayed on the display portion 22, the symbol column indicated by a third reel strip 103 corresponds to a symbol column variably displayed on the variable display portion 23, the symbol column indicated by a fourth reel strip 104 corresponds to a symbol column variably displayed on the variable display portion 24 and the symbol column indicated by a fifth reel strip 105 corresponds to a symbol column variably displayed on the variable display portion 25.

Here, the symbol columns respectively indicated by the first to fifth reel strips 101 to 105 have different symbol columns from each other and each symbol column is constructed from 12 symbols by voluntarily combining “WILD”, “SHARK”, “FISH”, “PUNK”, “OCTOPUS”, “CRAB”, “WORM”, “A”, “K”, “Q”, “J” and “SARDINE”.

Here, although “SHARK”, “FISH”, “PUNK”, “OCTOPUS”, “CRAB”, “WORM”, “SARDINE” are not shown, each symbol shows a shark, a fish, a person having a guitar, an octopus, a crab, a worm and a sardine, respectively. And each of “WILD”, “A”, “K”, “Q” and “J” shows a symbol of English character (s), respectively.

Further, “SARDINE” is a scatter symbol to shift to the bonus game as mentioned later and in a case that more than three “SARDINE” symbols are totally displayed on the variable display portions 21 to 25, the game state can be shifted to the bonus game.

And “WILD” is an almighty symbol which can be substituted for any of “SHARK”, “FISH”, “PUNK”, “OCTOPUS”, “CRAB”, “WORM”, “A”, “K”, and “J” However, “WILD” cannot be substituted for “SARDINE” which is the scatter symbol.

Here, in a case that the symbol columns indicated by the first to fifth reel strips 101 to 105 are scrolled on the variable display portions 21 to 25 and thereafter stopped and displayed, three symbols are stopped and displayed in each variable display portion, as mentioned in the above.

And various winning symbol combinations are preset based on plural kinds of symbol combinations and when the symbol combination corresponding to the winning symbol combination is stopped on the activated pay line, the payout is added to the credit corresponding to the winning symbol combination. This point is as same as that in the convention slot machine, thus explanation thereof will be omitted.

Next, it will be described a construction of control system in the slot machine 1 with reference to FIG. 10. FIG. 10 is a block diagram schematically showing a control system of the slot machine 1.

In FIG. 10, the control system of the slot machine 1 is basically constructed from a CPU 50, and a ROM 51 and a RAM 52 are connected to the CPU 50. In the ROM 51, a main process program mentioned later, a base game process program, a bonus game process program, a lottery table used when it is conducted lottery to determine the symbols which are stopped and displayed in the base game, a lottery table used when it is conducted lottery to determine the symbols which are stopped and displayed in the bonus game, and the other various programs necessary for control of the slot machine 1 and data tables. And the RAM 52 is a memory to temporarily store various data calculated by the CPU 50.

And to the CPU 50, a clock pulse generator 53 for generating standard clock pulses and a frequency divider 54 are connected, and a random number generator 55 for generating random numbers and a random number sampling circuit 56 are also connected. The random number sampled through the random number sampling circuit 56 is utilized in various lotteries of the winning symbol combinations and the like. Further, to the CPU 50, the COLLECT switch 45 attached to the COLLECT button 31, the GAME-RULES switch 46 attached to the GAME RULES button 32, the 1-BET switch 57 attached to the BET 1 PER LINE button 33, the 2-BET switch 58 attached to the BET 2 PER LINES button 34, the 3-BET switch 59 attached to the BET 3 PER LINES button 35, the 5-BET switch 60 attached to the BET 5 PER LINES button 36, the 8-BET switch 60 attached to the BET 8 PER LINES button 37, the WIN-START switch 47 attached to the WIN START FEATURE button 38, the 1-LINE switch 62 attached to the RED PLAY 1 LINE button 39, the 2-LINES switch 63 attached to the PLAY 2 LINES button 40, the 5-LINES switch 64 attached to the PLAY 5 LINES button 41, the 20-LINES switch 65 attached to the PLAY 20 LINES button 42, the 25-LINES switch 66 attached to the BLACK PLAY 25 LINES button 43 and the GAMBLE•RESERVE switch 48 attached to the GAMBLE RESERVE button 44 are connected, respectively. The CPU 50 conducts control to execute various operations each of which corresponds to each button, based on the switch signal output from each switch by press thereof.

Further, to the CPU 50, the coin sensor 49 arranged in the coin insertion slot 9 and the bill sensor 67 arranged in the bill insertion portion 10 are respectively connected. The coin sensor 49 detects coins inserted from the coin insertion slot 9 and the CPU 50 calculates the number of inserted coins based on the coin detection signal output from the coin sensor 49. The bill sensor 67 detects kinds and sum of the bill inserted from the bill insertion portion 10 and the CPU 50 calculates the credit number equal to the sum of bill, based on the bill detection signal output from the bill sensor 67.

To the CPU 50, a hopper 71 is connected through a hopper drive circuit 70. When a drive signal is output to the hopper drive circuit 70 from the CPU 50, the hopper 71 pays out a predetermined number of coins from the coin payout opening 15.

And to the CPU 50, a coin detection portion 73 is connected through a payout completion signal circuit 72. The coin detection portion 73 is arranged in the coin payout opening 15 and when the coin detection portion 73 detects that a predetermined number of coins are paid out from the coin payout opening 15, a coin payout detection signal is output to the payout completion signal circuit 72 from the coin detection portion 73, thereby the payout completion signal circuit 72 outputs a payout completion signal to the CPU 50. Further, to the CPU 50, the upper liquid crystal display 3 and the lower liquid crystal display 4 are connected through a liquid crystal drive circuit 74, and the upper liquid crystal display 3 and the lower liquid crystal display 4 are controlled by the CPU 50.

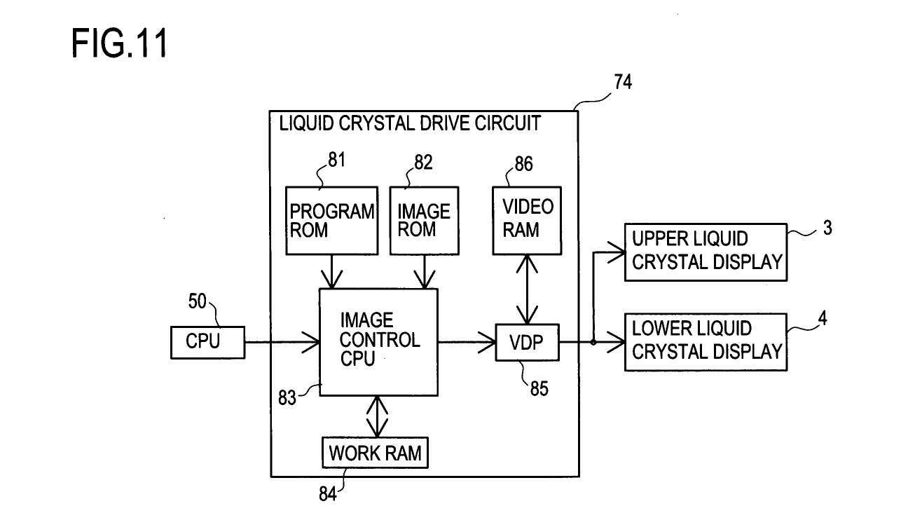

Here, as shown in FIG. 11, the liquid crystal drive circuit 74 is constructed from a program ROM 81, an image ROM 82, an image control CPU 83, a work RAM 84, a VDP (video display processor) 85 and a video RAM 68. And in the program ROM 81, there are stored an image control program for controlling display of the upper liquid crystal display 3 and the lower liquid crystal display 4 and various selection tables. And in the image ROM 82, for example, there are stored dot data for forming images of the symbol columns indicated by the first to fifth reel strips 101 to 105 in FIG. 12, such images being displayed on the lower liquid crystal display 4 (or variable display portions 21 to 25). And the image control CPU 83 determines the images displayed on the upper liquid crystal display 3 and the lower liquid crystal display 4 among the dot data stored beforehand in the image ROM 82, according to the image control program stored beforehand in the program ROM 81 based on parameters set by the CPU 50. Further, the work RAM 84 functions as temporary memory when the image control program is executed by the image control CPU 83. And the VDP 85 forms images corresponding to display contents determined by the image control CPU 83 and outputs such images to the upper liquid crystal display 3 and the lower liquid crystal display 4. Thereby, for example, the symbol columns indicated by the first to fifth reel strips 101 to 105 are scrolled and displayed on the lower liquid crystal display 4 (or the variable display portions 21 to 25). Here, the video RAM 86 functions as temporary memory when images are formed by the VDP 85.

And to the CPU 50, LEDs 78 are connected through a LED drive circuit 77. Many LEDs 78 are arranged on the front plane of the slot machine 1 and are controlled so as to turn on or turn off by the LED drive circuit 77 based on the drive signal from the CPU 50, when various effects are done. Further, a sound output circuit 79 and a speaker 80 are connected to the CPU 50 and the speaker 80 produces various effect sounds when various effects are conducted based on the output signal from the sound output circuit 79.

Here, it will be described with reference to FIG. 14 the lottery table which is used when the symbols stopped and displayed on the activated pay line constructed from the second stop display areas 212, 222, 232, 242 and 252 in the variable display portions 21 to 25 are determined, when the base game is conducted by using five variable display portions 21 to 25 in the slot machine 1. FIG. 14 is an explanatory view showing a lottery table of the stop display symbols used when the base game is conducted by utilizing five variable display portions 21 to 25.

The symbols stopped and displayed on the activated pay line constructed from the second stop display areas 212, 222, 232, 242 and 252 in the variable display portions 21 to 25 are determined every each of the variable display portions 21 to 25. In order to realize this, code Nos. “00”˜“29” are respectively allotted to the symbol in each symbol column indicated by the first to fifth reel strips 101 to 105 as shown in FIG. 12, in order of the upper most symbol. And the lottery table shown in FIG. 14 is provided beforehand. Further, five random numbers are sampled by the random number sampling circuit 56 so as to correspond to each of the variable display portions 21 to 25.

Hereinafter, the symbol column indicated by the first reel strip 101 in FIG. 12 will be described. The symbols in the symbol column are scrolled on the variable display portion 21. At that time, if the random number sampled by the random number sampling circuit 56 is “0”, the symbol “J” (English character) allotted to the code No. “00” is stopped and displayed on the activated pay line, if the random number is “1”, the symbol “Q” (English character) allotted to the code No “01” is stopped and displayed on the activated pay line, if the random number is “2”, the symbol “WILD” allotted to the code No. “02” is stopped and displayed on the activated pay line, if the random number is “3”, the symbol “J” (English character) allotted to the code No. “03” is stopped and displayed on the activated pay line, if the random number is “4”, the symbol “Q” (English character) allotted to the code No. “04” is stopped and displayed on the activated pay line, if the random number is “5”, the symbol “CRAB” allotted to the code No. “05” is stopped and displayed on the activated pay line, if the random number is “6”, the symbol “A” (English character) allotted to the code No. “06” is stopped and displayed on the activated pay line, if the random number is “7”, the symbol “WORM” allotted to the code No. “07” is stopped and displayed on the activated pay line, if the random number is “8”, the symbol “K” (English character) allotted to the code No. “08” is stopped and displayed on the activated pay line, if the random number is “9”, the symbol “FISH” allotted to the code No. “09” is stopped and displayed on the activated pay line, and if the random number is “10”, the symbol “PUNK” allotted to the code No. “10” is stopped and displayed on the activated pay line.

And if the random number is “11”, the symbol “Q” (English character) allotted to the code No. “11” is stopped and displayed on the activated pay line, if the random number is “12”, the symbol “SHARK” allotted to the code No. “12” is stopped and displayed on the activated pay line, if the random number is “13”, the symbol “CRAB” allotted to the code No. “13” is stopped and displayed on the activated pay line, if the random number is “14”, the symbol “K” (English character) allotted to the code No. “14” is stopped and displayed on the activated pay line, if the random number is “15”, the symbol “A” (English character) allotted to the code No. “15” is stopped and displayed on the activated pay line, if the random number is “16”, the symbol “OCTOPUS” allotted to the code No. “16” is stopped and displayed on the activated pay line, if the random number is “17”, the symbol “J” (English character) allotted to the code No. “17” is stopped and displayed on the activated pay line, if the random number is “18”, the symbol “Q” (English character) allotted to the code No. “18” is stopped and displayed on the activated pay line, and if the random number is “19”, the symbol “FISH” allotted to the code No. “19” is stopped and displayed on the activated pay line.

And if the random number is “20”, the symbol “K” (English character) allotted to the code No. “20” is stopped and displayed on the activated pay line, if the random number is “21”, the symbol “J” (English character) allotted to the code No. “21” is stopped and displayed on the activated pay line, if the random number is “22”, the symbol “SARDINE” allotted to the code No. “22” is stopped and displayed on the activated pay line, if the random number is “23”, the symbol “CRAB” allotted to the code No. “23” is stopped and displayed on the activated pay line, if the random number is “24”, the symbol “J” (English character) allotted to the code No. “24” is stopped and displayed on the activated pay line, if the random number is “25”, the symbol “WORM” allotted to the code No. “25” is stopped and displayed on the activated pay line, if the random number is “26”, the symbol “Q” (English character) allotted to the code No. “26” is stopped and displayed on the activated pay line, if the random number is “27”, the symbol “CRAB” allotted to the code No. “27” is stopped and displayed on the activated pay line, if the random number is “28”, the symbol “A” (English character) allotted to the code No. “28” is stopped and displayed on the activated pay line, and if the random number is “29”, the symbol “FISH” allotted to the code No. “29” is stopped and displayed on the activated pay line.

Here, as for the symbol column indicated by the second reel strip 102 in FIG. 12 the symbols of which are scrolled on the variable display portion 22, the symbol column indicated by the third reel strip 103 in FIG. 12 the symbols of which are scrolled on the variable display portion 23, the symbol column indicated by the fourth reel strip 104 in FIG. 12 the symbols of which are scrolled on the variable display portion 24 and the symbol column indicated by the fifth reel strip 105 in FIG. 12 the symbols of which are scrolled on the variable display portion 25, the above control is similarly conducted.

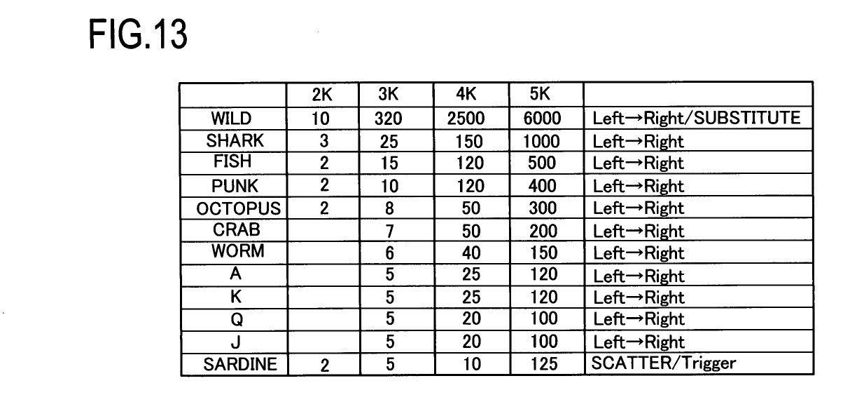

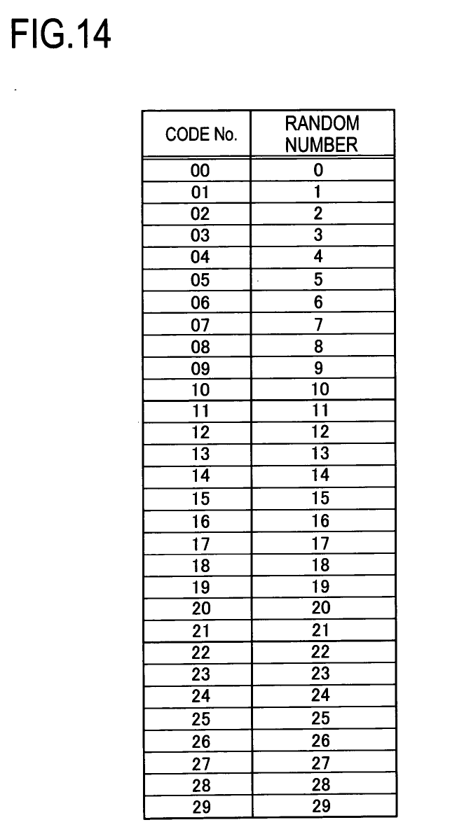

Next, with reference to FIG. 13, it will be described the winning symbol combinations and payouts thereof in a case that the base game is executed by using five variable display portions 21 to 25 in the slot machine 1. FIG. 13 is an explanatory view showing the winning symbol combinations and payouts thereof in a case that the base game is executed by using five variable display portions 21 to 25, and shows payouts in a case that the bet number is “1”. Therefore, if the bet number is “1”, the payout number shown in FIG. 13 is added to the credit, and if the bet number is more than “2”, the value obtained by multiplying the bet number with the payout number shown in FIG. 13 is added to the credit.

Here, concretely describing the winning symbol combinations and payouts thereof in the base game, as shown in FIG. 13, if the symbols “WILD” (shown in FIG. 13) are stopped and displayed in series along the activated pay line on the variable display portions 21 and 22 (if two symbols “WILD” appear in series from the left end (this case is called as “2K”)), the payout number “10” can be obtained. And if the symbols “WILD” are stopped and displayed in series along the activated pay line on the variable display portions 21 to 23 (if three symbols “WILD” appear in series from the left end (this case is called as “3K”)), the payout number “320” can be obtained. Further, if the symbols “WILD” are stopped and displayed in series along the activated pay line on the variable display portions 21 to 24 (if four symbols “WILD” appear in series from the left end (this case is called as “4K”)), the payout number “2500” can be obtained. And if the symbols “WILD” are stopped and displayed in series along the activated pay line on the variable display portions 21 to 25 (if five symbols “WILD” appear in series from the left end (this case is called as “5K”)), the payout number “6000” can be obtained.

And as for the symbol “SHARK”, if the symbols “SHARK” are stopped and displayed in series along the activated pay line on the variable display portions 21 and 22 (if two symbols “SHARK” appear in series from the left end (this case is called as “2K”)), the payout number “3” can be obtained. And if the symbols “SHARK” are stopped and displayed in series along the activated pay line on the variable display portions 21 to 23 (if three symbols “SHARK” appear in series from the left end (this case is called as “3K”)), the payout number “25” can be obtained. Further, if the symbols “SHARK” are stopped and displayed in series along the activated pay line on the variable display portions 21 to 24 (if four symbols “SHARK” appear in series from the left end (this case is called as “4K”)), the payout number “150” can be obtained. And if the symbols “SHARK” are stopped and displayed in series along the activated pay line on the variable display portions 21 to 25 (if five symbols “SHARK” appear in series from the left end (this case is called as “5K”)), the payout number “1000” can be obtained.

Here, as mentioned in the above, the symbol “WILD” can be substituted for the symbol “SHARK”.

And as for the symbol “FISH”, if the symbols “FISH” are stopped and displayed in series along the activated pay line on the variable display portions 21 and 22 (if two symbols “FISH” appear in series from the left end (this case is called as “2K”)), the payout number “2” can be obtained. And if the symbols “FISH” are stopped and displayed in series along the activated pay line on the variable display portions 21 to 23 (if three symbols “FISH” appear in series from the left end (this case is called as “3K”)), the payout number “15” can be obtained. Further, if the symbols “FISH” are stopped and displayed in series along the activated pay line on the variable display portions 21 to 24 (if four symbols “FISH” appear in series from the left end (this case is called as “4K”)), the payout number “120” can be obtained. And if the symbols “FISH” are stopped and displayed in series along the activated pay line on the variable display portions 21 to 25 (if five symbols “FISH” appear in series from the left end (this case is called as “5K”)), the payout number “500” can be obtained.

Here, as mentioned in the above, the symbol “WILD” can be substituted for the symbol “FISH”.

And as for the symbol “PUNK” (a person having a guitar), if the symbols “PUNK” are stopped and displayed in series along the activated pay line on the variable display portions 21 and 22 (if two symbols “PUNK” appear in series from the left end (this case is called as “2K”)), the payout number “2” can be obtained. And if the symbols “PUNK” are stopped and displayed in series along the activated pay line on the variable display portions 21 to 23 (if three symbols “PUNK” appear in series from the left end (this case is called as “3K”)), the payout number “10” can be obtained. Further, if the symbols “PUNK” are stopped and displayed in series along the activated pay line on the variable display portions 21 to 24 (if four symbols “PUNK” appear in series from the left end (this case is called as “4K”)), the payout number “120” can be obtained. And if the symbols “PUNK” are stopped and displayed in series along the activated pay line on the variable display portions 21 to 25 (if five symbols “PUNK” appear in series from the left end (this case is called as “5K”)), the payout number “400” can be obtained.

Here, as mentioned in the above, the symbol “WILD” can be substituted for the symbol “PUNK” (a person having a guitar).

And as for the symbol “OCTOPUS”, if the symbols “OCTOPUS” are stopped and displayed in series along the activated pay line on the variable display portions 21 and 22 (if two symbols “OCTOPUS” appear in series from the left end (this case is called as “2K”)), the payout number “2” can be obtained. And if the symbols “OCTOPUS” are stopped and displayed in series along the activated pay line on the variable display portions 21 to 23 (if three symbols “OCTOPUS” appear in series from the left end (this case is called as “3K”)), the payout number “8” can be obtained. Further, if the symbols “OCTOPUS” are stopped and displayed in series along the activated pay line on the variable display portions 21 to 24 (if four symbols “OCTOPUS” appear in series from the left end (this case is called as “4K”)), the payout number “50” can be obtained. And if the symbols “OCTOPUS” are stopped and displayed in series along the activated pay line on the variable display portions 21 to 25 (if five symbols “OCTOPUS” appear in series from the left end (this case is called as “5K”)), the payout number “300” can be obtained.

Here, as mentioned in the above, the symbol “WILD” can be substituted for the symbol “OCTOPUS”.

And as for the symbol “CRAB”, if the symbols “CRAB” are stopped and displayed in series along the activated pay line on the variable display portions 21 to 23 (if three symbols “CRAB” appear in series from the left end (this case is called as “3K”)), the payout number “7” can be obtained. Further, if the symbols “CRAB” are stopped and displayed in series along the activated pay line on the variable display portions 21 to 24 (if four symbols “CRAB” appear in series from the left end (this case is called as “4K”)), the payout number “50” can be obtained. And if the symbols “CRAB” are stopped and displayed in series along the activated pay line on the variable display portions 21 to 25 (if five symbols “CRAB” appear in series from the left end (this case is called as “5K”)), the payout number “200” can be obtained.

Here, as mentioned in the above, the symbol “WILD” can be substituted for the symbol “CRAB”.

And as for the symbol “WORM”, if the symbols “WORM” are stopped and displayed in series along the activated pay line on the variable display portions 21 to 23 (if three symbols “WORM” appear in series from the left end (this case is called as “3K”)), the payout number “6” can be obtained. Further, if the symbols “WORM” are stopped and displayed in series along the activated pay line on the variable display portions 21 to 24 (if four symbols “WORM” appear in series from the left end (this case is called as “4K”)), the payout number “40” can be obtained. And if the symbols “WORM” are stopped and displayed in series along the activated pay line on the variable display portions 21 to 25 (if five symbols “WORM” appear in series from the left end (this case is called as “5K”)), the payout number “150” can be obtained.

Here, as mentioned in the above, the symbol “WILD” can be substituted for the symbol “WORM”.

And as for the symbol “A” (English character), if the symbols “A” are stopped and displayed in series along the activated pay line on the variable display portions 21 to 23 (if three symbols “A” appear in series from the left end (this case is called as “3K”)), the payout number “5” can be obtained. Further, if the symbols “A” are stopped and displayed in series along the activated pay line on the variable display portions 21 to 24 (if four symbols “A” appear in series from the left end (this case is called as “4K”)), the payout number “25” can be obtained. And if the symbols “A” are stopped and displayed in series along the activated pay line on the variable display portions 21 to 25 (if five symbols “A” appear in series from the left end (this case is called as “5K”)), the payout number “120” can be obtained.

Here, as mentioned in the above, the symbol “WILD” can be substituted for the symbol “A (English character)”.

And as for the symbol “K” (English character), if the symbols “K” are stopped and displayed in series along the activated pay line on the variable display portions 21 to 23 (if three symbols “K” appear in series from the left end (this case is called as “3K”)), the payout number “5” can be obtained. Further, if the symbols “K” are stopped and displayed in series along the activated pay line on the variable display portions 21 to 24 (if four symbols “K” appear in series from the left end (this case is called as “4K”)), the payout number “25” can be obtained. And if the symbols “K” are stopped and displayed in series along the activated pay line on the variable display portions 21 to 25 (if five symbols “K” appear in series from the left end (this case is called as “5K”)), the payout number “120” can be obtained.

Here, as mentioned in the above, the symbol “WILD” can be substituted for the symbol “K (English character)”.

And as for the symbol “Q” (English character), if the symbols “Q” are stopped and displayed in series along the activated pay line on the variable display portions 21 to 23 (if three symbols “Q” appear in series from the left end (this case is called as “3K”)), the payout number “5” can be obtained. Further, if the symbols “Q” are stopped and displayed in series along the activated pay line on the variable display portions 21 to 24 (if four symbols “Q” appear in series from the left end (this case is called as “4K”)), the payout number “20” can be obtained. And if the symbols “Q” are stopped and displayed in series along the activated pay line on the variable display portions 21 to 25 (if five symbols “Q” appear in series from the left end (this case is called as “5K”)), the payout number “100” can be obtained.

Here, as mentioned in the above, the symbol “WILD” can be substituted for the symbol “Q (English character)”.

And as for the symbol “J” (English character), if the symbols “J” are stopped and displayed in series along the activated pay line on the variable display portions 21 to 23 (if three symbols “J” appear in series from the left end (this case is called as “3K”)), the payout number “5” can be obtained. Further, if the symbols “J” are stopped and displayed in series along the activated pay line on the variable display portions 21 to 24 (if four symbols “J” appear in series from the left end (this case is called as “4K”)), the payout number “20” can be obtained. And if the symbols “J” are stopped and displayed in series along the activated pay line on the variable display portions 21 to 25 (if five symbols “J” appear in series from the left end (this case is called as “5K”)), the payout number “100” can be obtained.

Here, as mentioned in the above, the symbol “WILD” can be substituted for the symbol “J (English character)”.

And in a case that the above payout is realized on plural activated pay lines, all payouts are added to the credit.

On the other hand, as for the symbol “SARDINE”, if two symbols “SARDINE” appear (are stopped and displayed) on the variable display portions 21 to 25 with no relation to the activated pay lines, that is, if the case “2K” is realized, the payout number “2” can be obtained. If three symbols “SARDINE” appear (are stopped and displayed) on the variable display portions 21 to 25 with no relation to the activated pay lines, that is, if the case “3K” is realized, the payout number “5” can be obtained. And if four symbols “SARDINE” appear (are stopped and displayed) on the variable display portions 21 to 25 with no relation to the activated pay lines, that is, if the case “4K” is realized, the payout number “10” can be obtained. Further, if five symbols “SARDINE” appear (are stopped and displayed) on the variable display portions 21 to 25 with no relation to the activated pay lines, that is, if the case “5K” is realized, the payout number “125” can be obtained.

Here, concerning with only the payout obtained by the symbol “SARDINE”, the payout number calculated by multiplying the payout number shown in FIG. 13 with the total bet number (a product of the bet number and the number of activated pay line) is added to the credit. At that time, if it exists the payout other than the payout on the basis of the symbol “SARDINE”, such payout is also added to the credit.

And as for the symbol “SARDINE”, in a case that more than three symbols “SARDINE” are totally stopped and displayed on the variable display portions 21 to 25 with no relation to the activated pay lines, not only the above payout can be obtained but also the game state can be shifted to the bonus game.

Here, the bonus game is a game which is conducted after the base game is terminated, and in many cases the bonus game is generally more beneficial for the player. If the game state shifts to the bonus game, 15˜25 games can be continuously and automatically executed without betting any credits corresponding to a result of the lottery conducted when the game state shifts to the bonus game.

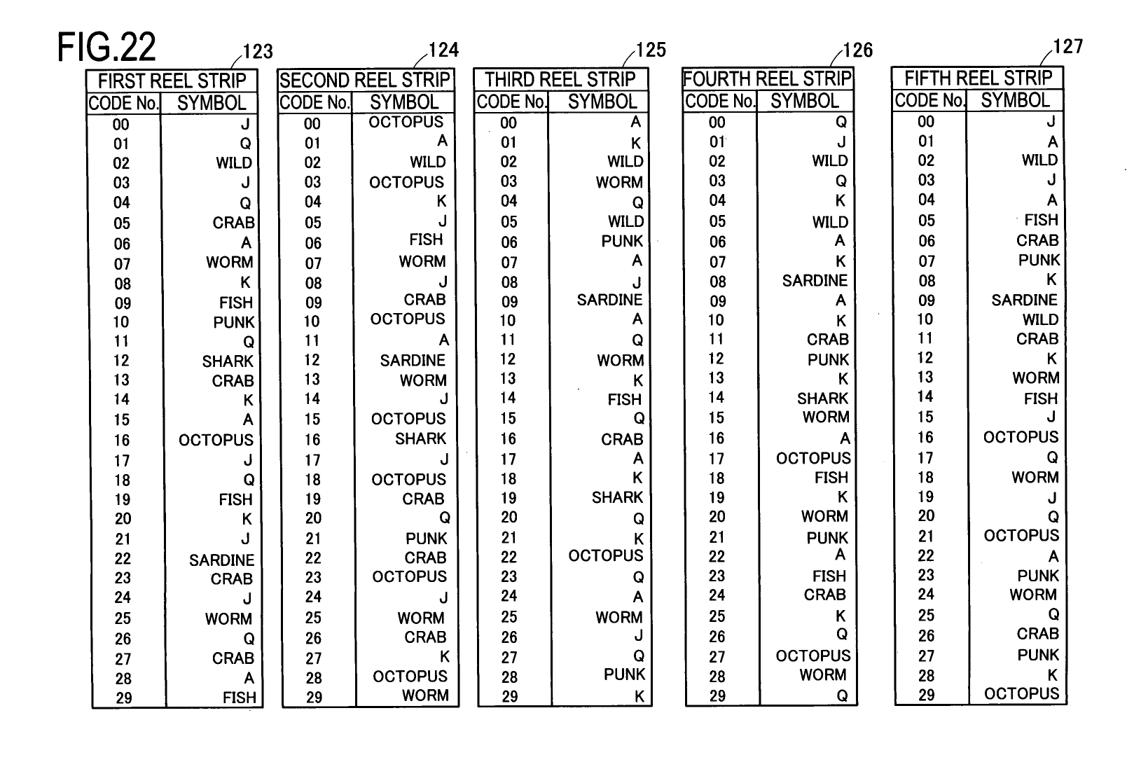

By the way, in the slot machine 1 according to the first embodiment, when the bonus game is conducted, the symbol column variably displayed while being scrolled on the variable display portion 21 of the lower liquid crystal display 4 is the symbol column indicated by the first reel strip 123 shown in FIG. 22, the symbol column variably displayed while being scrolled on the variable display portion 22 of the lower liquid crystal display 4 is the symbol column indicated by the second reel strip 124 shown in FIG. 22, the symbol column variably displayed while being scrolled on the variable display portion 23 of the lower liquid crystal display 4 is the symbol column indicated by the third reel strip 125 shown in FIG. 22, the symbol column variably displayed while being scrolled on the variable display portion 24 of the lower liquid crystal display 4 is the symbol column indicated by the fourth reel strip 126 shown in FIG. 22 and the symbol column variably displayed while being scrolled on the variable display portion 25 of the lower liquid crystal display 4 is the symbol column indicated by the fifth reel strip 127 shown in FIG. 22.

Here, the symbol columns indicated by the reel strips 123 to 126 shown in FIG. 22 are as same as those indicated by the reel strips 101 to 104 shown in FIG. 12. On the other hand, the symbol column indicated by the reel strip 127 shown in FIG. 22 is substantially as same as the symbol column indicated by the reel strip 105 shown in FIG. 22, except for the symbol “WILD” allotted to the code No. “10”.

Here, as the bet number and the number of activated pay line in the bonus game, the bet number and the number of activated pay line set in the base game are utilized, respectively. And in the bonus game, although the winning symbol combinations and payouts thereof in the bonus game are as same as those in the base game, the symbol “SHARK” is regarded as the symbol “WILD” and if more than three symbols “SARDINE” totally appear (are totally stopped and displayed), the game state in the bonus game can be again shifted to the bonus game. Therefore, the player can obtain a lot of credits in many cases.

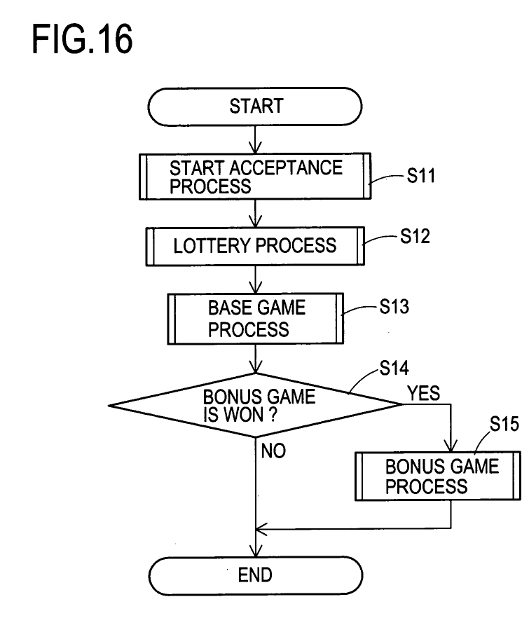

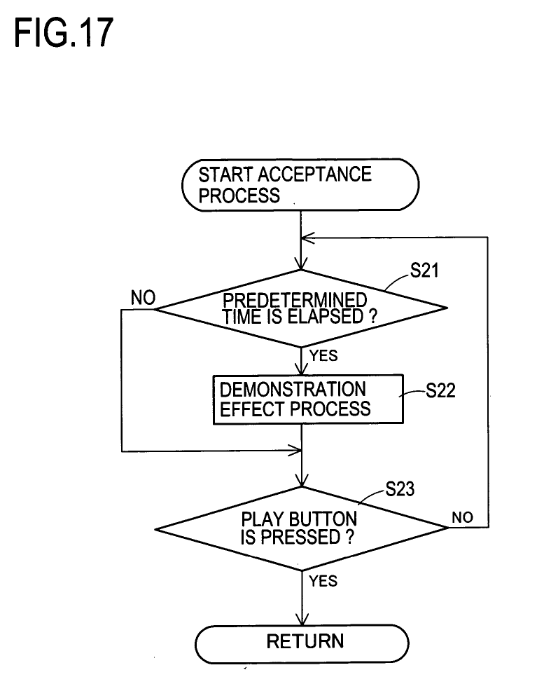

Next, the main process program executed in the slot machine 1 will be described with reference to FIG. 16. FIG. 16 is a flowchart of the main process program. In FIG. 16, at first, in step (abbreviated as “S” hereinafter) 11, a start acceptance process shown in FIG. 17 is executed. This process is a process for accepting the switch signal output from the 1-BET switch 57, the 2-BET switch 58, the 3-BET switch 59, the 5-BET switch 60, the 8-BET switch 61, the 1-LINE switch 62, the 2-LINES switch 63, the 5-LINES switch 64, the 20-LINES switch 65, the 25-LINES switch 66, based on operation of the BET 1 PER LINE button 33, the BET 2 PER LINES button 34, the BET 3 PER LINES button 35, the BET 5 PER LINES 36, the BET 8 PER LINES button 37, the RED PLAY 1 LINE button 39, the PLAY 2 LINES button 40, the PLAY 5 LINES button 41, the PLAY 20 LINES button 42 or the BLACK PLAY 25 LINES button 43. When the switch signal output from each switch is accepted, the game is started.

And in S12, a lottery process shown in FIG. 16 mentioned later is executed based on the switch signal output from the 1-LINE switch 62, the 2-LINES switch 63, the 5-LINES switch 64, the 20-LINES switch 65, the 25-LINES switch 66.

Here, if the bonus game is won, a repeat number of the bonus game is determined. In this case, for example, such repeat number is selected among 10˜25 games by a lottery.

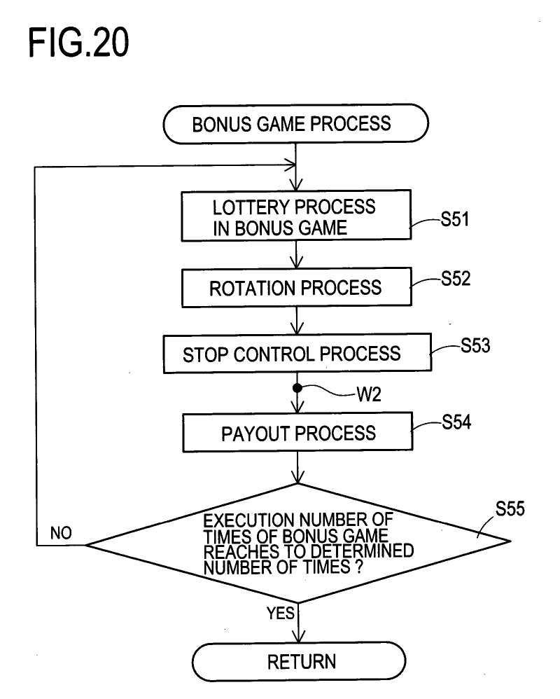

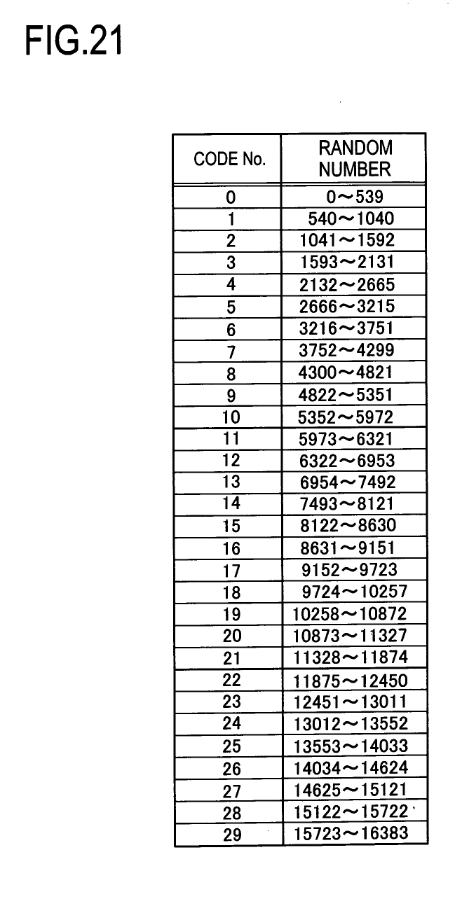

Next, in S13, a base game process shown in FIG. 20 mentioned later is executed. Thereafter, procedure shifts to S14 and it is determined whether or not the bonus game is won. Concretely, in the lottery process in S12, if more than three symbols “SARDINE” totally appear (are stopped and displayed) on the variable display portions 21 to 25 with no relation to the activated pay lines, the bonus game is won (S14: YES). Thereby, procedure shifts to S15 and the main process program is terminated after the bonus game process shown in FIG. 20 mentioned later is executed. On the other hand, in the lottery process of S12, if more than three symbols “SARDINE” does not totally appear (are not stopped and displayed) on the variable display portions 21 to 25 with no relation to the activated pay lines, the bonus game is not won (S14: NO), thereby the main process program is terminated.

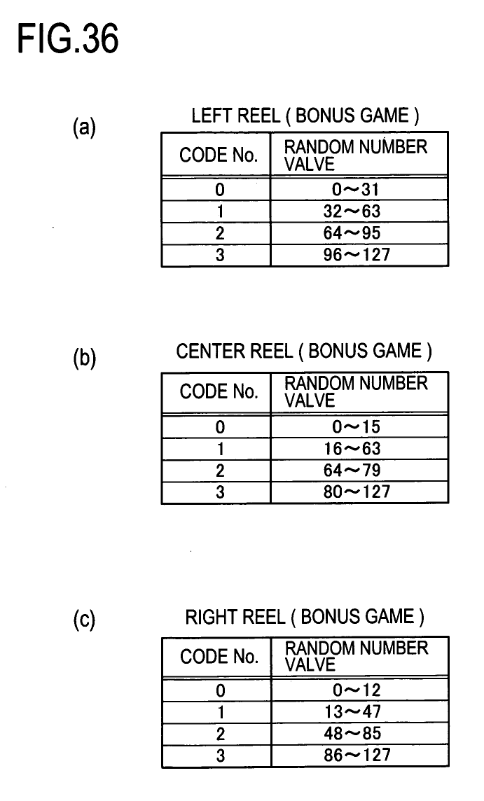

Next, the start acceptance process program conducted in the slot machine 1 will be described with reference to FIG. 17. FIG. 17 is a flowchart of the start acceptance process program. In S11 of the main process program shown in FIG. 16, the start acceptance process is conducted. Here, to conduct this process, at first, procedure shifts to S21 of FIG. 17 and it is determined whether or not a predetermined time (for example, 15 seconds) is elapsed. Here, if it is determined that the predetermined time is not elapsed (S21: NO), procedure shifts to S23, and on the other hand, if it is determined that the predetermined time is elapsed (S21: YES), demonstration effect is done on the upper liquid crystal display 3 or the lower liquid crystal display 4 in S22, thereafter procedure shifts to S23. And in S23, it is determined whether or not operation of the RED PLAY 1 LINE button 39, the PLAY 2 LINES button 40, the PLAY 5 LINES button 41, the PLAY 20 LINES button 42 or the BLACK PLAY 25 LINES button 43 is done. Here, if it is determined that operation of the RED PLAY 1 LINE button 39 and the like is not done (S23: NO), procedure returns to S21 and the above procedures are repeated. On the other hand, if it is determined that operation of the RED PLAY 1 LINE button 39 and the like is done (S23: YES), procedure returns to the main process program of FIG. 36 and shifts to the lottery process in S12 even while the demonstration effect is done.

Here, in the determination process in S23, such determination in S23 may be conducted based on the other input signals other than the above operation signals.

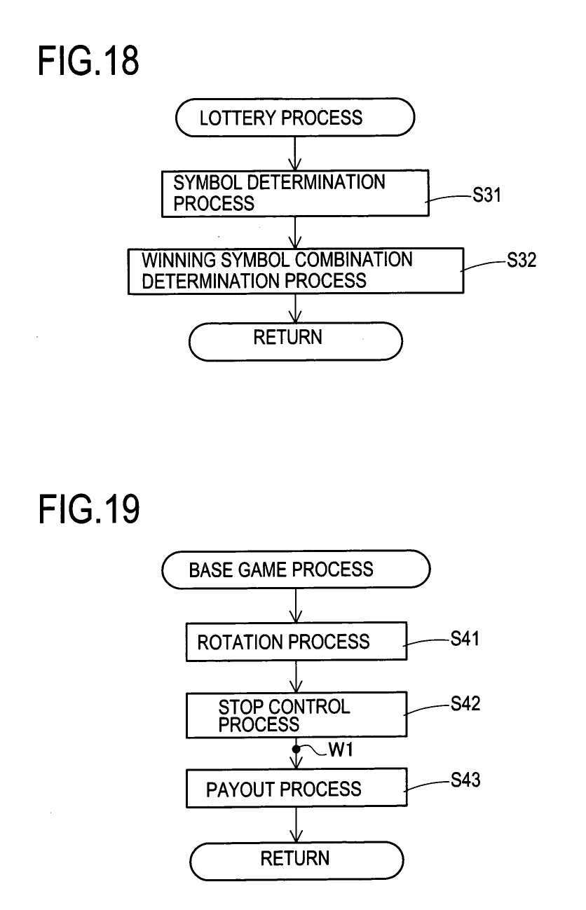

Next, the lottery process program executed in the slot machine 1 will be described with reference to FIG. 18. FIG. 18 is a flowchart of the lottery process program. In S12 of the main process program shown in FIG. 16, the lottery process is executed. To conduct this process, at first, procedure shifts to S31 of FIG. 18 and a symbol determination process is conducted. Here, the symbols stopped and displayed on the activated pay line constructed from the second stop display areas 212, 222, 232, 242 and 252 in the variable display portions 21 to 25 in the base game are determined every each of the variable display portions 21 to 25. Concretely, as mentioned above, five random number values are sampled by the random number sampling circuit 56 so as to correspond to each of the variable display portions 21 to 25 and the symbols stopped and displayed are determined through the code Nos. based on the lottery table shown in FIG. 14. And if the symbols stopped and displayed on the activated pay line are determined, a determination process of the winning symbol combination is executed in S32, thereafter procedure returns to the main process program in FIG. 16 and shifts to the base game process in S13. Here, concretely speaking, in the determination process of the winning symbol combination, the winning symbol combination and the payout thereof are determined based on the table shown in FIG. 13 through the code No. obtained in S31, as mentioned.

Next, the base game process program executed in the slot machine 1 will be described with reference to FIG. 19. FIG. 19 is a flowchart of the base game process program. In S13 of the main process program shown in FIG. 16, the base game is conducted. To realized this, at first, in S41 of FIG. 19, scroll of each of the symbols is done on the variable display portions 21 to 25 based on the switch signal output from the 1-LINE switch 62, the 2-LINES switch 63, the 5-LINES switch 64, the 20-LINES switch 65 or the 25-LINES switch 66, the switch signal being accepted in S11 of FIG. 16.

And in S42, scroll of each of the symbols on the variable display portions 21 to 25 is stopped.

Further, in S43, according to the symbol combination corresponding to the winning symbol combination stopped and displayed on the variable display portions 21 to 25, the credit corresponding to the payout determined on the basis of the table shown in FIG. 13 is paid out. Here, after process in S43 is executed, procedure shifts to the main process program shown in FIG. 16 and shifts to the determination process in S14.

Next, the bonus game process program executed in the slot machine 1 will be described with reference to FIG. 20. FIG. 20 is a flowchart of the bonus game process program. In S14 of the main process program shown in FIG. 16, if it is determined that the bonus game is won (S14: YES), procedure shifts to S15 of FIG. 16 and the bonus game process is conducted. To realize this, at first, procedure shifts to S51 shown in FIG. 20 and the lottery process during the bonus game is executed. Here, in the bonus game, the symbols stopped and displayed on the pay line constructed from the second stop display areas 212, 222, 232, 242 and 252 in the variable display portions 21 to 25 are determined every each of the variable display portions 21 to 25. Concretely, as mentioned, five random number values are sampled by the random number sampling circuit 56 so as to correspond to each of the variable display portions 21 to 25, and the symbols stopped and displayed are determined through the code Nos. based on the lottery table shown in FIG. 14. And if the symbols stopped and displayed on the pay line are determined, the winning symbol combination and the payout thereof are determined based on the table shown in FIG. 13 through the code Nos.

Further, in the rotation process in S52, scroll of each of the symbols is automatically done on the variable display portions 21 to 25.

And in the stop control process in S53, scroll of each of the symbols on the variable display portions 21 to 25 is stopped.

Further, in the payout process in S54, according to the symbol combination corresponding to the winning symbol combination stopped and displayed on the variable display portions 21 to 25, the credit corresponding to the payout determined based on the table in FIG. 13 (however, the symbol “SHARK” is regarded as the symbol “WILD” (English characters)) is paid out.

Next, procedure shifts to S55 and it is determined whether or not the execution number of times of the bonus game reaches to the number of times determined in S12 of FIG. 16. At that time, if it is determined that the execution number of times of the bonus game does not reach to the number of times already determined in S12 of FIG. 16 (S55: NO), procedure returns to S51 and the above processes are repeated. On the other hand, if it is determined that the execution number of times of the bonus game reaches to the number of times already determined in S12 of FIG. 16 (S55: YES), the bonus game process program is terminated.

Here, if the bonus game is won in S51, the repeat number of times of the bonus game is determined again and the determined repeat number of times is added to the “number of times determined in S12 of FIG. 16” used in the determination process in S55. Thereby, when the bonus game is won during the bonus game, procedure can again shift to the bonus game. Concretely speaking, for example, in a case that procedure shifts to the bonus game with 20 number of times for the first time and the bonus game with 17 number of times is won in the twelfth bonus game, the bonus games are conducted in 25 times (20 times−12 times+17 times) thereafter.

And if the credit can be finally obtained in the bonus game, a double down game to bet the credit is executed after the bonus game is terminated. This double down game will be omitted.

As mentioned in the above, the CPU 50 functions as “game controller” when the main process program of FIG. 16 is executed.

By the way, in the base game conducted in the slot machine 1 of the first embodiment, in a case that the symbol “WILD” (ENGLISH characters) is stopped and displayed on the activated pay line when the symbols are stopped and displayed on each of the variable display portions 21 to 25, if any of the winning symbol combinations shown in the table of FIG. 13 is realized by regarding the symbol “WILD” (ENGLISH characters) on the activated pay line as any of the symbol “SHARK”, “FISH”, “PUNK”, “OCTOPUS”, “CRAB”, “WORM”, “A”, “K”, “Q”, “J”, the symbol regarded so as to realize the winning symbol combination is displayed instead of the symbol “WILD” (English characters).

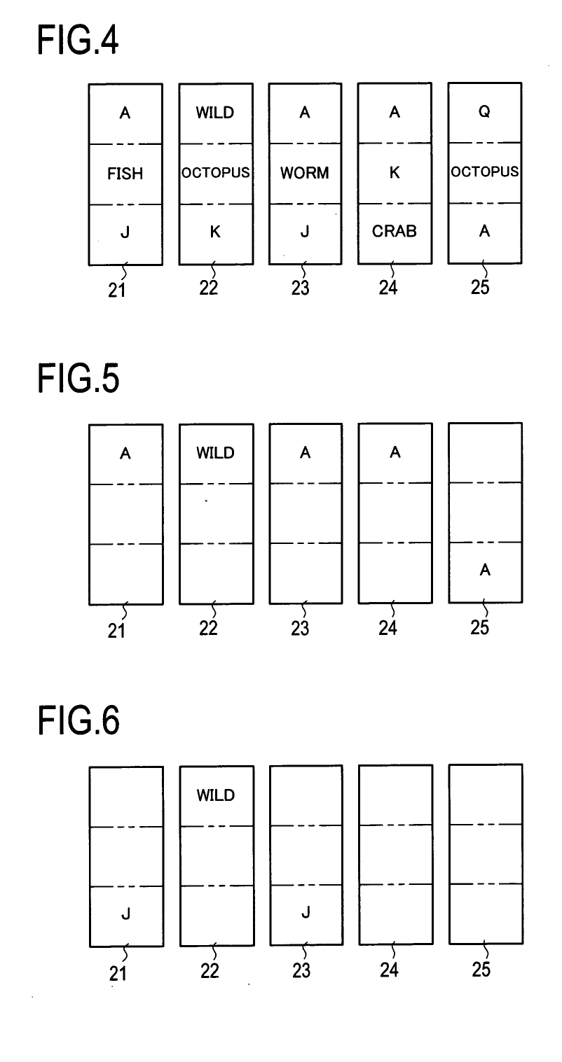

Concretely speaking, for example, for sake of explanation convenience, supposed that all of twenty-five pay lines are activated, in a case that the symbols are stopped and displayed on each of the variable display portions 21 to 25 as shown in FIG. 4, on the activated pay line constructed from the first stop display areas 211, 221, 231, 241 and the third stop display area 253 in the variable display portions 21 to 25 (see FIG. 15), if the symbol “WILD” on the activated pay line (the first stop display area 221 of the variable display portion 22) is regarded as the symbol “A”, it concludes that the winning symbol combination, in which five symbols “A” continuously appear from the left end of the activated pay line, is realized, as shown in FIG. 5. And on the activated pay line constructed from the second stop display area 221 and the third stop display areas 213, 233, 243 and 253 in the variable display portions 21 to 25 (see FIG. 15), if the symbol “WILD” on the activated pay line (the first stop display area 221 of the variable display portion 22) is regarded as the symbol “J”, it concludes that the winning symbol combination, in which three symbols “J” continuously appear from the left end of the activated pay line, is realized, as shown in FIG. 6. At that time, however, it is not easy for the player to recognize at sight that such winning symbol combination is realized from the symbols stopped and displayed on each of the variable display portions 21 to 25, shown in FIG. 4. Therefore, after the symbols are stopped and displayed on each of the variable display portions 21 to 25 as shown in FIG. 4, the symbol “A” is displayed instead of the symbol “WILD” stopped and displayed on the first stop display area 221 of the variable display portion 22 and further the symbol “J” is displayed.

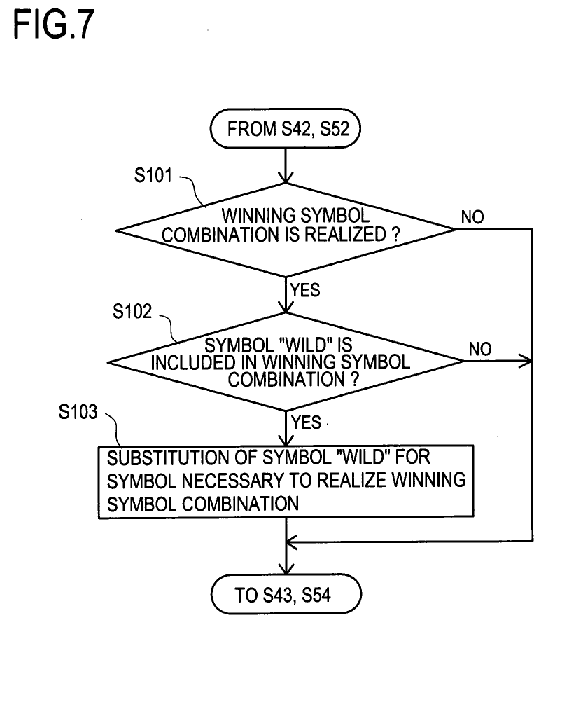

In order to realize the above, for example, the process shown in FIG. 7 is conducted at the timing W1 right after the stop control process of S42 in the base game process program of FIG. 19 is executed. That is to say, in the base game process program in FIG. 19, after the stop control process in S42 is conducted, procedure shifts to S101 in FIG. 7 and it is determined whether or not the winning symbol combination is realized according to the symbol combination on the activated pay line. When this determination is done, the symbol “WILD” on the activated pay line can be regarded as any of the symbol “SHARK”, the symbol “FISH”, the symbol “PUNK”, the symbol “OCTOPUS”, the symbol “CRAB”, the symbol “WORM”, the symbol “A”, the symbol “K”, the symbol “Q” and the symbol “J”.

At that time, it is determined that the winning symbol combination is not realized according to the symbol combination on the activated pay line (S101: NO), procedure returns to the base game process program in FIG. 19 and shifts to the payout process in S43. On the other hand, if it is determined that the winning symbol combination is realized according to the symbol combination on the activated pay line (S101: YES), procedure shifts to S102.

Here, in determination of S101, it may be utilized the determination result obtained in the determination process of the winning symbol combination in S32 in the lottery process of FIG. 18.

And in S102, it is determined whether or not the symbol “WILD” is included in the symbol combination on the activated pay line based on which winning symbol combination is realized. At that time, if it is determined that the symbol “WILD” is not included in the symbol combination on the activated pay line based on which winning symbol combination is realized (S102: NO), procedure returns to the base game process program in FIG. 19 and shifts to the payout process in S43. On the other hand, if it is determined that the symbol “WILD” is included in the symbol combination on the activated pay line based on which the winning symbol combination is realized (S102: YES), procedure shifts to S103.

And in S103, it is instructed to the image control CPU 83 to conduct display that the symbol “WILD” on the activated pay line is substituted for the symbol necessary to realize the winning symbol combination. At that time, in a case that plural symbols necessary to realize the winning symbol combination exist, the image control CPU 83 display to substitute the symbol “WILD” for such symbols one by one.

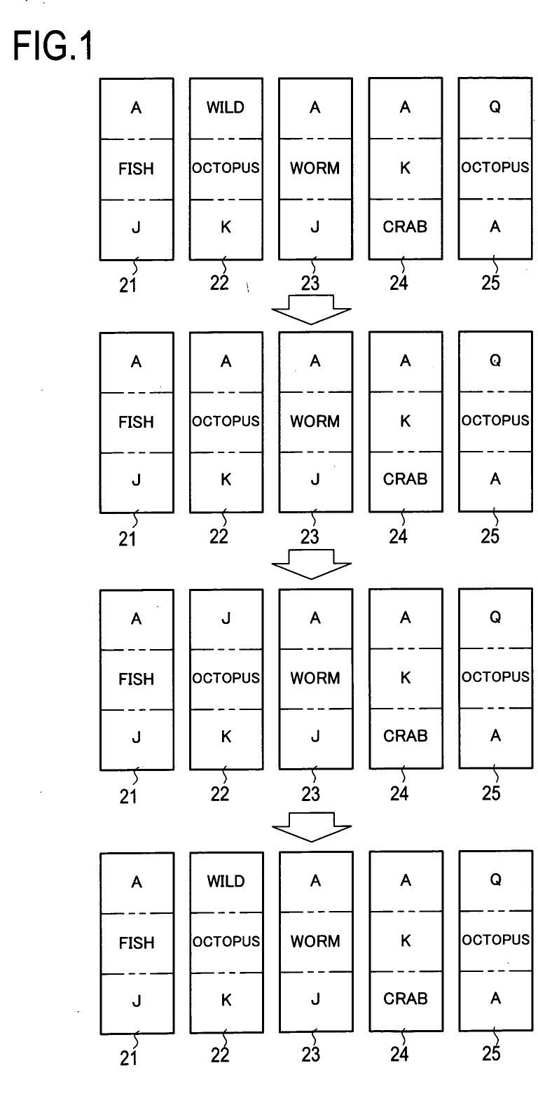

Concretely speaking, for example, for sake of explanation convenience, supposed that all of twenty-five pay lines are activated, in a case that the symbols are stopped and displayed on each of the variable display portions 21 to 25 as shown in FIG. 4, the substitution display shown in FIG. 1 is conducted. That is to say, when the symbols are stopped and displayed, the symbol display state in each of the variable display portions 21 to 25 is shown in the uppermost display example in FIG. 1. Thereafter, as shown in the second display example in FIG. 1, in stead of the symbol “WILD”, which is stopped and displayed in the first stop display area 221 (see FIG. 15) of the variable display portion 22 on the activated pay line constructed from the first stop display areas 211, 221, 231, 241 and the third stop display area 253 in each of the variable display portions 21 to 25, the symbol “A” is displayed. Further, thereafter, as shown in the third display example shown in FIG. 1, instead of the symbol “A”, which is stopped and displayed in the first stop display area 221 (see FIG. 15) of the variable display portion 22 on the activated pay line constructed from the second stop display area 221 and the third stop display areas 213, 233, 243 and 253 in each of the variable display portions 21 to 25, the symbol “J” is displayed in the first stop display area 221. Further, thereafter, as shown in the lowermost display example in FIG. 1, instead of the symbol “J” stopped and displayed in the first stop display area 221 (see FIG. 15) of the variable display portion 22, the symbol “WILD” is displayed in the first stop display area 221. Thereby, the display state returns to the state when the symbols are stopped and displayed.

Here, after the process in S103 is conducted, procedure returns to the base game process program in FIG. 19 and shifts to the payout process in S43.

Therefore, the image control CPU 83 functions as a display control device when executing the instruction in the process of S103 of FIG. 7.

And in a case that the process shown in FIG. 7 is executed at the timing W2 right after the stop control process in S53 is executed in the bonus game process program shown in FIG. 20, the same display control as that mentioned in the above can be also conducted in the bonus game. However, in the bonus game, the symbol “SHARK” is similarly handled to the symbol “WILD” and after the process in S103 in FIG. 7 is executed, procedure returns to the bonus game process in FIG. 20, thereafter procedure shifts to the payout process in S54.

As mentioned in detail, in the base game conducted in the slot machine 1 according to the first embodiment, in a case that the symbol “WILD” is included in the symbol combination stopped and displayed on each of the variable display portions 21 to 25 of the lower liquid crystal display 4, based on that the symbol “WILD” is substituted for any of the symbol “SHARK”, the symbol “FISH”, the symbol “PUNK”, the symbol “OCTOPUS”, the symbol “CRAB”, the symbol “WORM”, the symbol A”, the symbol “K”, the symbol “Q”, the symbol “J”, if such symbol combination becomes any of the winning symbol combinations shown in the table of FIG. 13 (S101: YES, S102: YES), the symbol “WILD “is really substituted for any of the symbol “SHARK”, the symbol “FISH”, the symbol PUNK”, the symbol OCTOPUS”, the symbol “CRAB”, the symbol “WORM”, the symbol “A”, the symbol “K”, the symbol “Q”, the symbol “J”, and displayed on each of the variable display portions 21 to 25 of the lower liquid crystal display 4 (S103).

Describing according to the above example, for sake of explanation convenience, supposed that all of twenty-five pay lines are activated, as shown in the second display example in FIG. 1, in stead of the symbol “WILD”, which is stopped and displayed in the first stop display area 221 (see FIG. 15) of the variable display portion 22, the symbol “A” is displayed. By this substitution and display of the symbol “A”, on the activated pay line constructed from the first stop display areas 211, 221, 231, 241 and the third stop display area 253 (see FIG. 15), the winning symbol combination in which five symbols “A” continuously appear from the left end of the pay line is directly displayed. Therefore, the player can recognize at sight such winning symbol combination.

And in the above example, as shown in the third display example, in stead of the symbol “A” stopped and displayed in the first stop display area 221 see FIG. 15) of the variable display portion 22, the symbol “J” is displayed. By this substitution and display of the symbol “J”, on the activated pay line constructed from the second stop display area 221 and the third stop display area 213, 233, 243, 253 (see FIG. 15), the winning symbol combination in which three symbols “J” continuously appear from the left end of the pay line is directly displayed.

As mentioned, in a case that the symbols are stopped and displayed on each of the variable display portions 21 to 25, when a plurality of winning symbol combinations are realized on the activated pay line, substitution and display is reciprocally conducted every the winning symbol combination, thereby the player can recognize at sight one by one each of plural winning symbol combinations realized. At that time, the order of substitution and display of the symbol may be determined according to amount of the payout or may be determined according to the number allotted to the activated pay line.

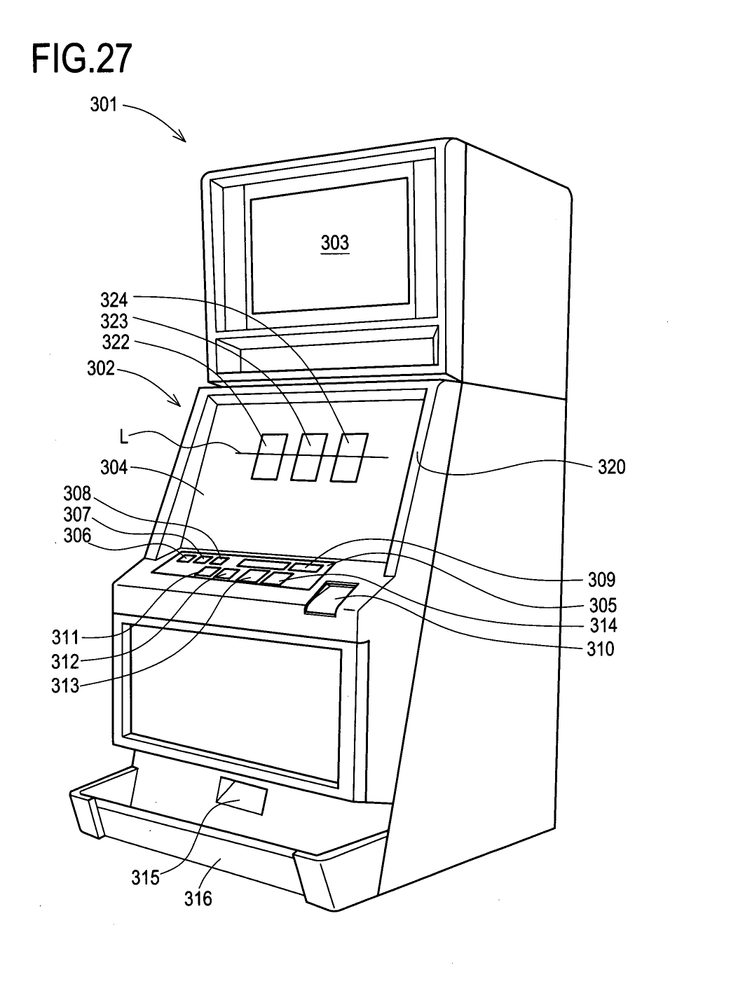

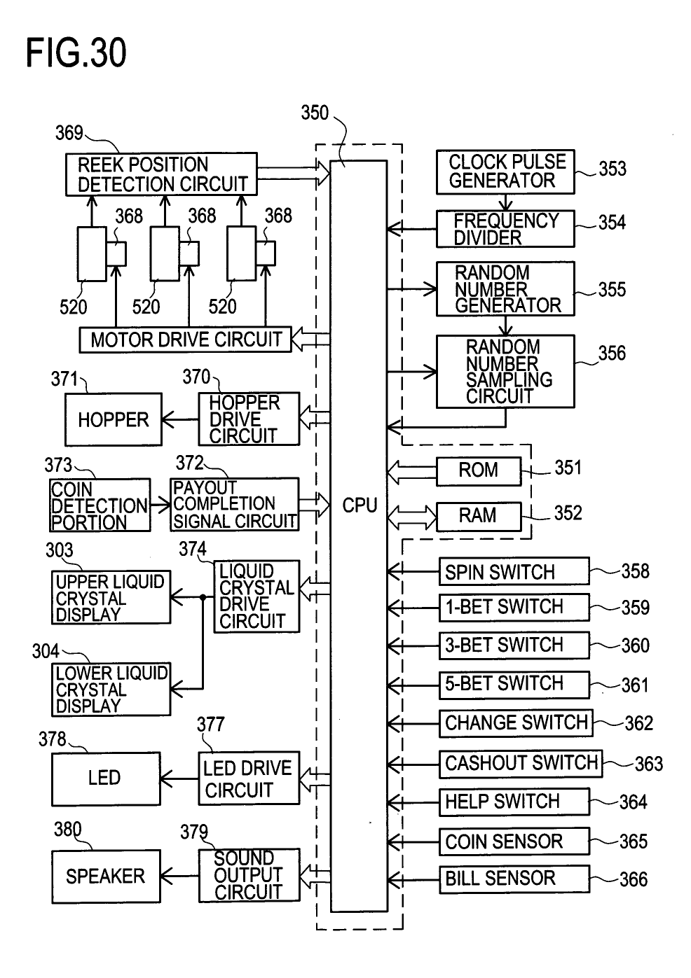

Hereinafter, as the gaming machine according to the present invention, the second embodiment embodying the present invention in the slot machine will be described with reference to the drawings. First, an outline construction of the slot machine according to the second embodiment will be described with reference to FIGS. 27 and 30. FIG. 27 is a perspective view of the slot machine. FIG. 30 is a block diagram schematically showing a control system in the slot machine In FIG. 27, the slot machine 301 has a cabinet 302 constructing a whole of the slot machine 301. At a front upper part of the cabinet 302 an upper liquid crystal display 303 is arranged, and at a front central part of the cabinet 302 a lower liquid crystal display 304 is arranged. Here, the upper liquid crystal display 303 is constructed from a liquid crystal display device which is generally used, and the lower liquid crystal display 304 is constructed from, so-called, a transmissive liquid crystal display device. On the upper liquid crystal display 303, game operation method, kinds of winning symbol combinations and payout therefor and information concerning with the game such as various effects thereof are displayed. And on the lower liquid crystal display 304, as shown in FIG. 27, three variable display portions 322, 323 and 324 are basically displayed and various symbols (mentioned later) are scrolled to the downward direction from the upward direction while being variably displayed on each of the variable display portions 322 to 324 (hereinafter, called as “scroll display”). Here, the detailed construction of the lower liquid crystal display 304 will be described hereinafter.

A control panel 305, which is projected frontward, is formed below the lower liquid crystal display 304, and from the most left side on the control panel 305, a change button 306, a payout (cashout) button 307, a help button 308 are arranged. And a coin insertion slot 309 and a bill insertion portion 310 are arranged at the right side of help button 308. Further, from the left side, a 1-BET button 311, a SPIN/REPEAT BET button 312, a 3-BET button 313 and a 5-BET button 314 are positioned at the front side on the control panel 305.

Here, to the change button 306, a change switch 362 is attached, and a switch signal is output to a CPU 350 from the change switch 362 based on press of the change button 306.

The payout button 307 is usually pressed when games are terminated, and when the payout button 307 is pressed coins got in games are paid out through the coin payout chute 315 to the coin tray 316. Here, to the payout button 307, a payout (cashout) switch 363 is attached and a switch signal is output to the CPU 350 from the payout switch 363 based on press of the payout button 307.

The help button 308 is pressed when the player cannot understand game operation method, and when the help button 308 is pressed, various help information is displayed on the upper liquid crystal display 303 or the lower liquid crystal display 304. To this help button 308, a help switch 364 is attached and a switch signal is output to the CPU 350 from the help switch 364 based on press of the help button 308.

To the coin insertion slot 309, a coin sensor 365 is positioned, and when the coin is inserted in the coin insertion slot 309 a coin detection signal is output to the CPU 350 through the coin sensor 365. And to the bill insertion portion 310 a bill sensor 366 is positioned, and when the bill is inserted in the bill insertion portion 310 a bill detection signal is output to the CPU 350 through the bill sensor 366.

As for the 1-BET button 311, every the 1-BET button 311 is pressed one credit is betted, and to the 1-BET button 311, a 1-BET switch 359 is attached and when the 1-BET button 311 is pressed a switch signal is output to the CPU 350 from the 1-BET switch 359 based on press of the 1-BET button 311.

The SPIN/REPEAT BET button 312 is the button to start games from the present bet number or the previous bet number by press thereof, thereby variable display of the symbols is started on the variable display portions 321 to 325 of the lower liquid crystal display 304. To the SPIN/REPEAT BET button 312, a spin switch 358 is attached, and when the SPIN/REPEAT BET button 312 is pressed a switch signal is output to the CPU 350 from the spin switch 358 based on press of the SPIN/REPEAT BET button 312. Here, as the bet number which can be betted by press of the SPIN/REPEAT BET button 312, there may exist 1, 2, 3 and 5 bets.

The 3-BET button 313 is the button to start games from 3 bets on the basis of press thereof. To this 3-BET button 313, a 3-BET switch 360 is attached and when the 3-BET button 313 is pressed a switch signal is output to the CPU 350 from the 3-BET switch 360. And the 5-BET button 314 is the button to start games from 5 bets on the basis of press thereof. To the 5-BET button 314, a 5-BET switch 361 is attached and when the 5-BET button 314 is pressed a switch signal is output to the CPU 350 from the 5-BET switch 361 on the basis of press thereof.

Further, at the lower part of the cabinet 302, the coin payout chute 315 is formed and the coin tray 316 to receive coins paid out from the coin payout chute 315 is provided. In the coin payout chute 315, a coin detection part 373 constructed from a sensor and the like is positioned and the coin detection part 373 detects the number of coins paid out from the coin payout chute 315.

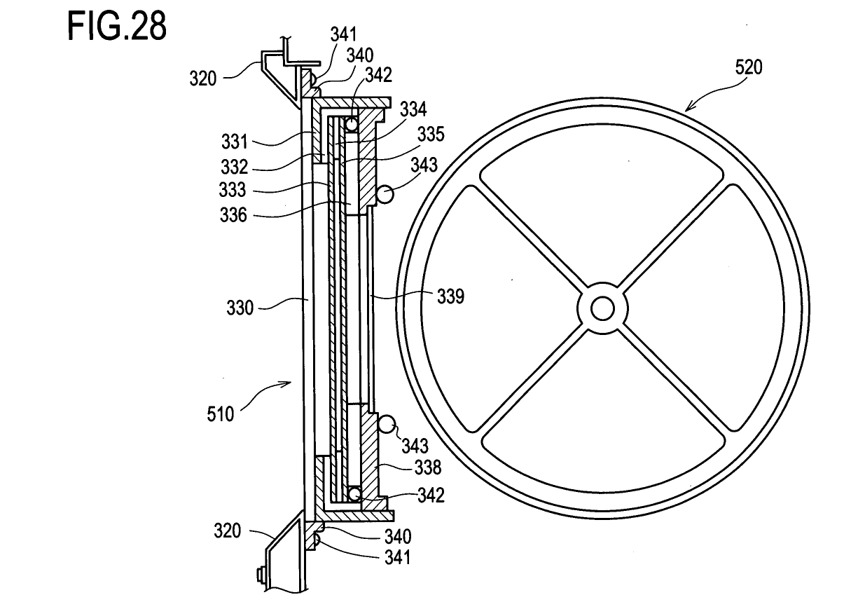

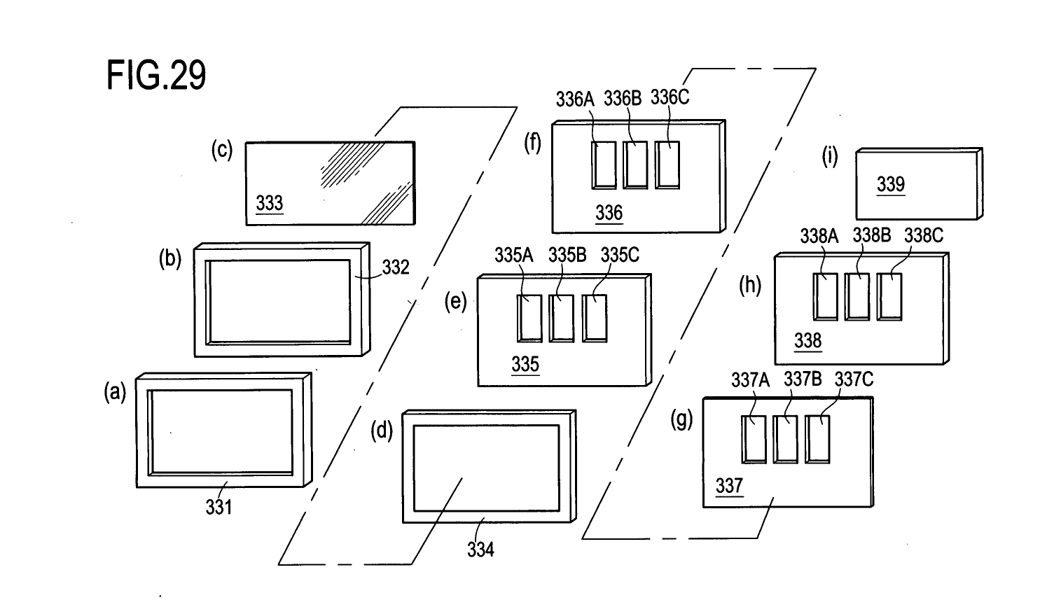

Next, it will be described a detailed construction of the lower liquid crystal display 304 and reels rotatably arranged behind the lower liquid crystal display 304 in the cabinet 302, with reference to FIGS. 28 and 29. FIG. 28 is a longitudinal sectional view of the lower liquid crystal display and the reels, and FIG. 29 is an exploded perspective view of the lower liquid crystal display 304.

In FIGS. 28 and 29, the lower liquid crystal display 304 is arranged within a display window 321 of a device front panel 320 positioned at the front center part of the cabinet 302 in the slot machine 301, with a touch panel 330 arranged at the front side (the left side in FIG. 28) of the lower liquid crystal display 304. And at the rear side (the right side in FIG. 28) of the lower liquid crystal display 304, three reels 520 (only one reel 520 is indicated in FIG. 28) are supported in a parallel state so that the reels 520 become independently rotatable.

That is to say, as shown in FIG. 28, the lower liquid crystal display 304 is arranged in front of three reels 520. And a bonus game mentioned later is conducted on the lower liquid crystal display 304 and a base game mentioned later is conducted on the reels 520.

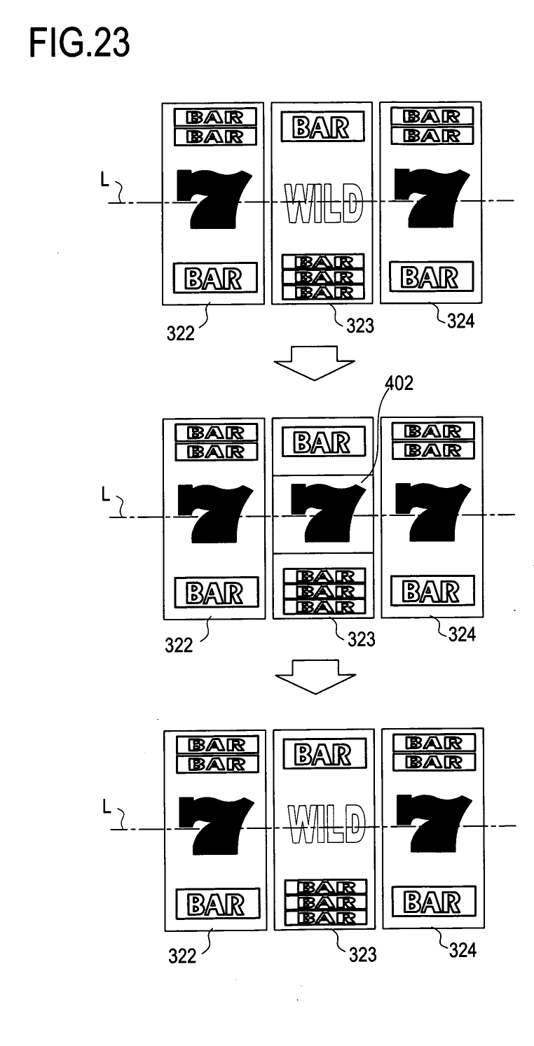

Here, each reel 520 will be described. Among three reels 520, the left reel 520 when seen from the front plane of the slot machine 301 faces to a display portion 322 (see FIG. 23) formed in the lower liquid crystal display 304, the center reel 520 faces to a display portion 323 (see FIG. 23) similarly formed in the lower liquid crystal display 304 and the right reel 520 faces to a display portion 324 (see FIG. 23) similarly formed in the lower liquid crystal display 304.

Here, construction of each of the variable display portions 322 to 324 will be described hereinafter.

Next, construction of the lower liquid crystal display 304 will be described with reference to FIGS. 28 and 29. In FIGS. 28 and 29, the lower liquid crystal display 304 is constructed by arranging from the front side of the slot machine 301; the transmissive touch panel 330, the reel glass base 331, the bezel metal frame 332, the transmissive liquid crystal panel 333, the liquid crystal holder 334, the diffusion sheet 335, the light guiding plate 336, the white reflector 337, the rear holder 338 and the antistatic sheet 339. In the diffusion sheet 335, three openings 335A, 335B, 335C are formed. Similarly, in the light guiding plate 336, the reflector 337 and the rear holder 338, three openings 336A, 336B, 336C, 337A, 337B, 337C, 338A, 338B, 338C are formed respectively, so as to coincide with the openings 335A, 335B, 335C. Here, the openings 335A˜338A construct the variable display portion 322 (see FIG. 23) by superimposing so as to coincide with each other. Similarly, the openings 335B˜338B construct the variable display portion 323 (see FIG. 23) by superimposing so as to coincide with each other and the openings 335C˜338C construct the variable display portion 324 (see FIG. 23) by superimposing so as to coincide with each other.

Here, the openings 335A˜335C of the diffusion sheet 335 and the openings 336A˜336C of the light guiding plate 336 construct the light transmitting areas to retain visibility of the variable display portions 322 to 324.

In order to install the lower liquid crystal display 304 to the display window 510 of the device front panel 320, as shown in FIG. 28, brackets 340 are screwed to the rear side of the device front panel 320 by screws 341.

And at an upper and lower ends of the light guiding plate 336, a pair of cathode ray tubes 342 are arranged as light source of the liquid crystal panel 333. And at an upper and lower positions in the rear side of each of openings 338A˜338C in the holder 338, a pair of cold cathode ray tubes 343 may be arranged.

The liquid crystal panel 333 is a transmissive electric display panel on which transmissive electrodes such as Ito are formed, and the circumference in rear side of the display portion of the liquid crystal panel 333 is held by the liquid crystal holder 334. The light guiding plate 336 is made of the light transmitting resin panel, and in the light guiding plate 336 lens cut portions are formed, the lens cut portions guiding light emitted from the cathode ray tubes 342 positioned at side positions to the rear side of the liquid crystal panel 333. The light diffusion sheet 335 is made from a light transmitting resin sheet and diffuses light led thereto by the light guiding plate 336 and levels light irradiated to the liquid crystal panel 333. The liquid crystal holder 334 for holding the liquid crystal panel 333, the diffusion sheet 335 and the light guiding plate 336 are assembled into one-piece construction and circumference thereof is inserted in the bezel metal frame 332. Thereby, the front side of the display portion in the liquid crystal panel 333 is retained by the bezel metal frame 332.

Circumferences of the liquid crystal holder 334, the light diffusion sheet 335 and the light guiding plate 336, which are inserted in the bezel metal frame 332 and assembled into one-piece construction, is further inserted in the reel glass base 331 and retained by the reel glass base 331 in a state that the front display plane of the liquid crystal panel 333 is opened. The transmissive touch panel 330 is pressed to the front face of the reel glass base 331 and superimposed on the front face of display portion of the liquid crystal panel 333 based on that the reel glass base 331 is attached to the device front panel 320 by screws 341.

The rear holder 338 is made from a white resin plate and retains to the reel glass base 331 the bezel metal frame 332 supported to the reel glass base 331, the liquid crystal holder 334 holding the liquid crystal panel 333, the light diffusion sheet 335 and the light guiding plate 336 from the rear sides thereof. The rear holder 338 also functions as a reflecting plate for reflecting light emitted from the cathode ray tubes 342 to the light guiding plate 336 toward the liquid crystal panel 333. The antistatic sheet 339 is made transmissive and adhered to the rear plane of the rear holder 338 by double-sided adhesive tape, thereby the antistatic sheet 339 covers the rear plane of each of the openings 338A 338C formed in the rear holder 338.

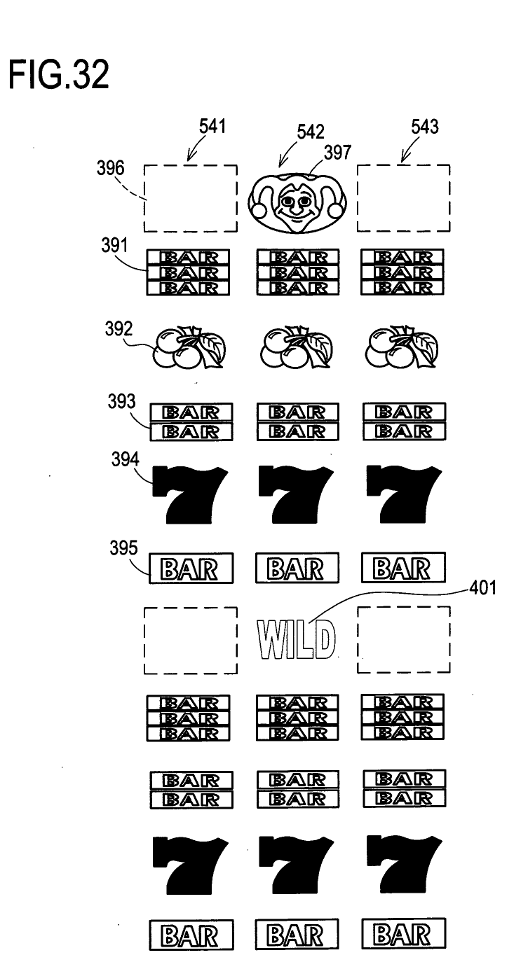

And on the outer periphery of each of the reels 520, various symbols shown in FIG. 32, the symbols being used in the base game, are formed. FIG. 32 is an explanatory view showing the symbol columns which are formed on each of the reels 520 and variably displayed while being scrolled through each of the variable display portions 322 to 324 of the lower liquid crystal display 304, the variable display portions 322 to 324 being made transmissive in the base game. In FIG. 32, the symbol column 541 indicates the symbol column variably displayed in the variable display portion 322, the symbol column 542 indicates the symbol column variably displayed in the variable display portion 323 and the symbol column 543 indicates the symbol column variably displayed in the variable display portion 324.

Here, the symbol columns 541 and 543 commonly have the same arrangement of the symbols and such arrangement of the symbols is constructed from eleven symbols in which the triple BAR 391, the cherry 392, the double BAR 393, the symbol seven 394, the single BAR 395 and the blank (no symbol exists) 396 are voluntarily combined.

And although the symbol column 542 is as same as the symbol column 541 and 543 at the point that the triple BAR 391, the cherry 392, the double BAR 393, the symbol seven 394, the single BAR 395 and the blank 396 are combined, one trigger symbol 397 and one wild symbol 401 are further arranged in the symbol column 542. This trigger symbol 397, as mentioned hereinafter, functions as a symbol to shift to the bonus game from the base game, and when the trigger symbol 397 is stopped and displayed on the pay line L in the variable display portion 323, the game condition shifts to the bonus game from the base game. Further, the wild symbol 401 is the almighty symbol which can be substituted for any of the triple BAR 391, the cherry 392, the double BAR 393, the symbol seven 394, the single BAR 395 and the blank 396, other than the wild symbol 401. However, the wild symbol 401 cannot be substituted for the trigger symbol 397.

Here, when the symbol columns 541 to 543, which are scrolled on the variable display portions 322 to 324 respectively, are stopped and displayed thereon, three symbols are stopped and displayed on each variable display portions 322 to 324.

And various winning symbol combinations are set beforehand based on a plurality of symbol combinations and when the symbol combination corresponding to the winning symbol combination is stopped on the pay line L, coins are paid out from the coin payout chute 315 according to the winning symbol combination. The above mentioned points are as same as those in the conventional slot machine, therefore detailed description thereof will be omitted. And formation of the symbols on the outer periphery of the reel 520 is generally done as follows. First, symbols and blanks are printed on a long reel sheet having a width and a length corresponding to the width and the periphery length of the reel 520, respectively. And such reel sheet is adhered on the peripheral plane of the reel 520. Of course, the symbols may be formed by different method other than the above method.

Next, it will be described a construction of the control system in the slot machine 301 with reference to FIG. 30. FIG. 30 is a block diagram schematically showing the control system in the slot machine 301.

In FIG. 30, the control system of the slot machine 301 is basically constructed from the CPU 350, and a ROM 351 and a RAM 352 are connected to the CPU 350. The ROM 351 stores a main process program mentioned later, a base game process program, a bonus game process program, a lottery table utilized in lottery of the symbols stopped and displayed in the base game, a lottery table utilized in lottery of the symbols stopped and displayed in the bonus game, various programs necessary for controlling the slot machine 301 and various data tables and the like. And the RAM 352 is a memory for temporarily storing various data (for example, ON•OFF information of flag which is switched according to whether the bonus game is realized or not) calculated by the CPU 350.

And to the CPU 350, a clock pulse generator 353 for generating standard clock pulses and a frequency divider 354 are connected, and a random number generator 355 and a sampling circuit 356 are also connected. Random number sampled by the random number generator 356 is utilized in various lotteries of the winning symbol combinations, the effects and the like. Further, to the CPU 350, the spin switch 358 attached to the SPIN/REPEAT BET button 312, the 1-BET switch 359 attached to the 1-BET button 311, the 3-BET switch 360 attached to the 3-BET button 313, the 5-BET switch 361 attached to the 5-BET button 314, the change switch 362 attached to the change button 306, the payout switch 363 attached to the payout button 307 and the help switch 364 attached to the help button 308 are connected respectively. The CPU 350 controls the slot machine 301 to execute various operations corresponding to each button, based on the switch signal output from each switch when such buttons are pressed.

To the CPU 350, three stepping motors 368 for rotating each of the reels 520 through a motor drive circuit 467 are connected, and also a reel position detection circuit 369 is connected. When a motor drive signal is output to the motor drive circuit 467, each stepping motor 368 is driven to rotate by the motor drive circuit 467, thereby each reel 520 is rotated.

At that time, after each reel 520 is started to rotate, the number of drive pulses provided to each stepping motor 368 is calculated and the calculated value is written in the predetermined area of the RAM 352. And the reset pulse is output every one rotation of the reel 520 and such reset pulse is input to the CPU 350 through the reel position detection circuit 369. When the reset pulse is input to the CPU 350, the calculated value written in the RAM 352 is cleared in “0”, and the CPU 350 recognizes the symbol rotational position in the reel 520, based on the calculated value corresponding to the rotational position of the reel 520 within one rotation and the symbol table in which the rotational position of the reel 520 stored in the ROM 351 and the symbols formed on outer peripheral plane of the reel 520 are corresponded with each other.

Further, to the CPU 350, the coin sensor 365 positioned in the coin insertion slot 309 and the bill sensor 366 positioned in the bill insertion portion 310 are connected respectively. The coin sensor 365 detects coins inserted from the coin insertion slot 309 and the CPU 350 calculates the number of inserted coins based on the coin detection signal output from the coin sensor 365. The bill sensor 366 detects the kind and sum of bill and the CPU 350 calculates the number of coins equivalent to sum of bill, based on the bill detection signal output from the bill sensor 366.

To the CPU 350, a hopper 371 is connected through a hopper drive circuit 370. When a drive signal is output to the hopper circuit 370 from the CPU 350, the hopper 371 pays out predetermined number of coins from the coin payout chute 315.

And to the CPU 350, a coin detection part 373 is connected through a payout completion signal circuit 372. The coin detection part 373 is arranged in the coin payout chute 315 and when the coin detection part 373 detects that a predetermined number of coins are paid out from the coin payout chute 315, the payout completion signal is output to the payout completion signal circuit 372 from the coin detection part 373. Based on this, the payout completion signal circuit 372 outputs the payout completion signal to the CPU 350. Further, to the CPU 350, the upper liquid crystal display 303 and the lower liquid crystal display 304 are connected through a liquid crystal drive circuit 374. Thereby, the upper liquid crystal display 303 and the lower liquid crystal display 304 are controlled by the CPU 350.

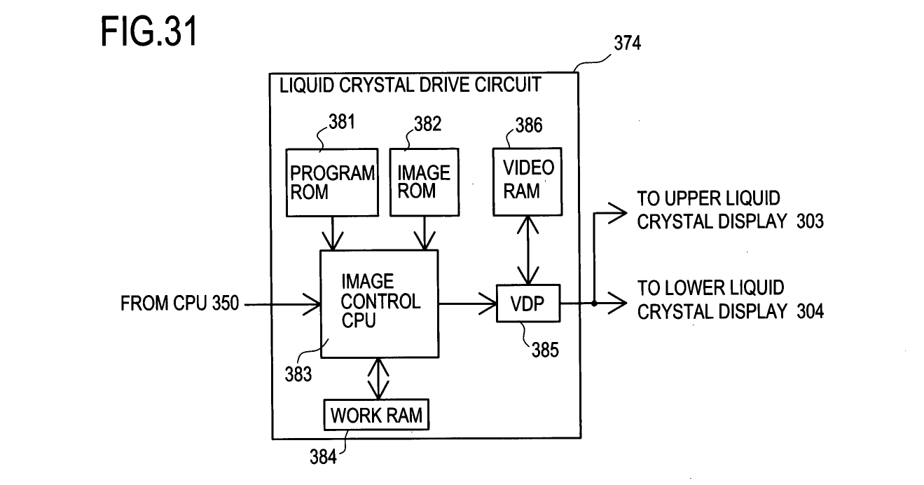

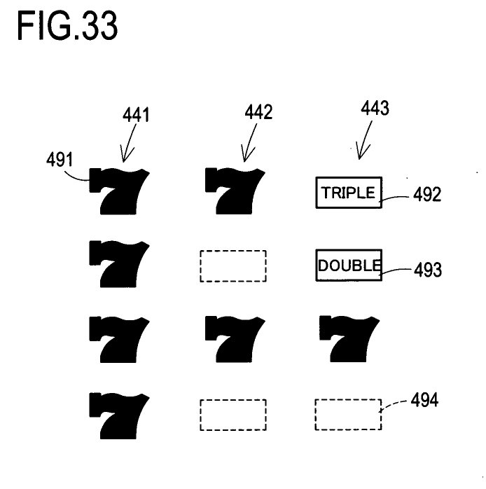

At this point of view, as shown in FIG. 31, the liquid crystal drive circuit 374 is constructed from a program ROM 381, an image ROM 382, an image control CPU 383, a work RAM 384, a VDP (Video Display Processor) 385 and a video RAM 386. And in the program ROM 381, an image control program concerning with display on the lower liquid crystal display 304 and various selection tables are stored. Further, in the image ROM 382, for example, it is stored dot data for forming images on the upper liquid crystal display 303 and dot data for forming images such as the triple BAR 391, the cherry 392, the double BAR 393, the symbol seven 394, the single BAR 395 and the blank 396 of FIG. 32 displayed on the lower liquid crystal display 304 (or the variable display portions 322 to 324) and such as the symbol columns 441 to 443 shown in FIG. 33. And the image control CPU 383 determines images displayed on the upper liquid crystal display 303 and the lower liquid crystal display 304 among the dot data stored in the image ROM 382 beforehand, according to the image control program stored in the program ROM 381 based on parameters set by the CPU 350. And the work RAM 384 functions as the temporary memory when the above image control program is executed by the image control CPU 383. Further, the VDP 385 forms images corresponding to display contents determined by the image control CPU 383 and outputs the images to the upper liquid crystal display 303 and the lower liquid crystal display 304. Thereby, for example, the triple BAR 391, the cherry 392, the double BAR 393, the symbol seven 394, the single BAR 395 and the blank 396 of FIG. 32 are displayed on the lower liquid crystal display 304 (or the variable display portions 322 to 324) or the symbol columns 441˜443 of FIG. 33 are scrolled and displayed on the lower liquid crystal display 304 (or variable display portions 322 to 324). Here, the video RAM 386 functions as the temporary memory when images are formed by the VDP 385.

Here, the symbol columns 441 to 443 of FIG. 33 stored in the image ROM 382 will be described. The symbol columns 441 to 443 of FIG. 33 are utilized in the bonus game mentioned later. And there exist three kinds of symbols such as the seven symbol 491, the triple symbol 492 and the double symbol 493, and such three kinds of the seven symbol 491, the triple symbol 492, the double symbol 493 and the blank 494 (no symbol exists) are combined with a predetermined combination, thereby twelve symbols and blanks are totally formed.

Here, various winning symbol combinations are preset based on plural kinds of the symbol combinations and when the symbol combination corresponding to the winning symbol combination is stopped on the pay line L, coins are paid out through the coin payout opening 315 according to the winning symbol combination. This operation is as same as that in the conventional slot machine, thus explanation thereof will be omitted.

And to the CPU 350, LEDs 378 are connected through a LED drive circuit 377. A plurality of LEDs 378 are arranged on the front plane of the slot machine 301 and the LEDs 378 are controlled so as to turn on based on the drive signals from the CPU 350. Further, a speaker 380 and a sound output circuit 379 are connected to the CPU 350 and the speaker 380 produces various effective sounds when various effects are conducted based on the output signal from the sound output circuit 379.

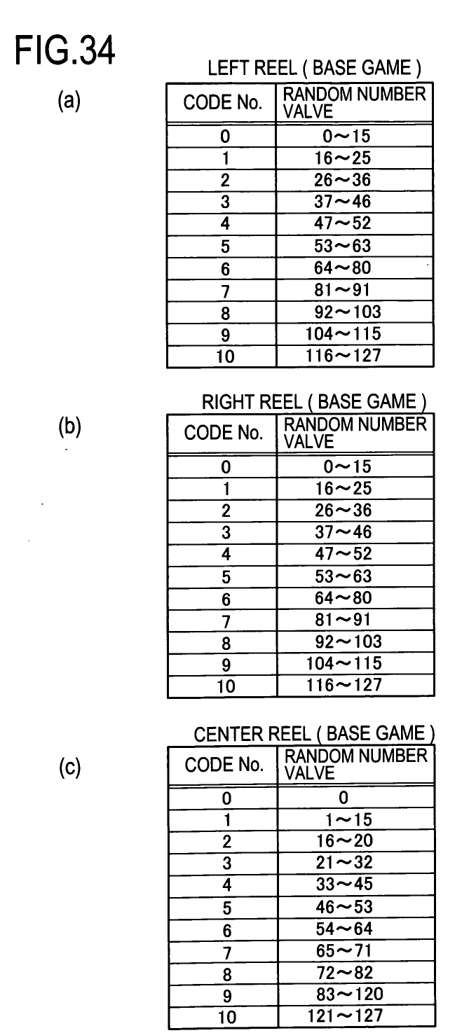

Here, in a case that the base games are conducted in the slot machine 301, the lottery table utilized when the symbols (symbols formed on the outer periphery of each of the reels 520) stopped and displayed on the pay line L are determined will be described with reference to FIG. 34. The base game is conducted by utilizing three reels 520 with the symbols each of which can be seen through the variable display portions 322 to 324 that are made transmissive during the base game. FIG. 34 is an explanatory view showing the lottery table based on which the symbols of the reels 520 to be stopped and displayed through the transmissive variable display portions 322 to 324 are determined when the base game is conducted while utilizing the reels 520.

The symbols stopped and displayed on the pay line L are determined every each of three reels 520. In order to realize this, one of the code numbers “0”˜“10” is allotted to each symbol in the symbol columns 541 to 543 of three reels 520 shown in FIG. 32, and it is provided the lottery table shown in FIG. 34. Further, three random number values are sampled corresponding to each of three reels 520, through the random number sampling circuit 356.

Here, in FIG. 34, for explanatory convenience, the reel 520 on which the symbol column 541, which can be seen through the transmissive left variable display portion 322, is formed is indicated as the “left reel”, the reel 520 on which the symbol column 543, which can be seen through the transmissive right variable display portion 324, is formed is indicated as the “right reel”, and the reel 520 on which the symbol column 542, which can be seen through the transmissive center variable display portion 323, is formed is indicated as the “center reel”.

As for the “left reel” corresponding to the symbol column 541, if the random number value sampled by the random number sampling circuit 356 lies in a range of 0˜15, the blank 396 allotted to the code number “0” is stopped and displayed on the pay line L. And if the random number value lies in a range of 16˜25, the triple BAR 391 allotted to the code number “1” is stopped and displayed on the pay line L, and if the random number value lies in a range of 26˜36, the cherry 392 allotted to the code number “2” is stopped and displayed on the pay line L. If the random number value lies in a range of 37˜46, the double BAR 393 allotted to the code number “3” is stopped and displayed on the pay line L, and if the random number value lies in a range of 47˜52, the symbol seven 394 allotted to the code number “4” is stopped and displayed on the pay line L. If the random number value lies in a range of 53˜63, the single BAR 395 allotted to the code number “5” is stopped and displayed on the pay line L, and if the random number value lies in range of 64˜80, the blank 396 allotted to the code number “6” is stopped and displayed on the pay line L. If the random number value lies in a range of 81˜91, the triple BAR 391 allotted to the code number “7” is stopped and displayed on the pay line L, and if the random number value lies in a range of 92˜103, the double BAR 393 allotted to the code number “8” is stopped and displayed on the pay line L. If the random number value lies in a range of 104˜115, the symbol seven 394 allotted to the code number “9” is stopped and displayed on the pay line L, and if the random number value lies in a range of 116˜127, the single BAR 395 allotted to the code number “10” is stopped and displayed on the pay line L.

And as for the “right reel” corresponding to the symbol column 543, there is the same relation as that in the above left reel. And if the random number value sampled by the random number sampling circuit 356 lies in a range of 0˜15, the blank 396 allotted to the code number “0” is stopped and displayed on the pay line L. And if the random number value lies in a range of 16˜25, the triple BAR 391 allotted to the code number “1” is stopped and displayed on the pay line L, and if the random number value lies in a range of 26˜36, the cherry 392 allotted to the code number “2” is stopped and displayed on the pay line L. If the random number value lies in a range of 37˜46, the double BAR 393 allotted to the code number “3” is stopped and displayed on the pay line L, and if the random number value lies in a range of 47˜52, the symbol seven 394 allotted to the code number “4” is stopped and displayed on the pay line L. If the random number value lies in a range of 53˜63, the single BAR 395 allotted to the code number “5” is stopped and displayed on the pay line L, and if the random number value lies in range of 64˜80, the blank 396 allotted to the code number “6” is stopped and displayed on the pay line L. If the random number value lies in a range of 81˜91, the triple BAR 391 allotted to the code number “7” is stopped and displayed on the pay line L, and if the random number value lies in a range of 92˜103, the double BAR 393 allotted to the code number “8” is stopped and displayed on the pay line L. If the random number value lies in a range of 104˜115, the symbol seven 394 allotted to the code number “9” is stopped and displayed on the pay line L, and if the random number value lies in a range of 116˜127, the single BAR 395 allotted to the code number “10” is stopped and displayed on the pay line L.

On the other hand, as for the “center reel” corresponding to corresponding to the symbol column 542, if the random number value sampled by the random number sampling circuit 56 is 0 (zero), the trigger symbol 397 allotted to the code number “0” is stopped and displayed on the pay line L. And if the random number value lies in a range of 1˜15, the triple BAR 391 allotted to the code number “1” is stopped and displayed on the pay line L, and if the random number value lies in a range of 16˜20, the cherry 392 allotted to the code number “2” is stopped and displayed on the pay line L. And if the random number value lies in a range of 21˜32, the double BAR 393 allotted to the code number “3” is stopped and displayed on the pay line L, and if the random number value lies in a range of 33˜45, the symbol seven 394 allotted to the code number “4” is stopped and displayed on the pay line L. And if the random number value lies in a range of 46˜53, the single BAR 395 allotted to the code number “5” is stopped and displayed on the pay line L, and if the random number value lies in a range of 54˜64, the wild symbol 401 allotted to the code number “6” is stopped and displayed on the pay line L. And if the random number value lies in a range of 65˜71, the triple BAR 391 allotted to the code number “7” is stopped and displayed on the pay line L, and if the random number value lies in a range of 72˜82, the double BAR 393 allotted to the code number “8” is stopped and displayed on the pay line L. And the random number value lies in a range of 83˜120, the symbol seven 394 allotted to the code number “9” is stopped and displayed on the pay line L, and if the random number value lies in a range of 121˜127, the single BAR 395 allotted to the code number “10” is stopped and displayed on the pay line L.

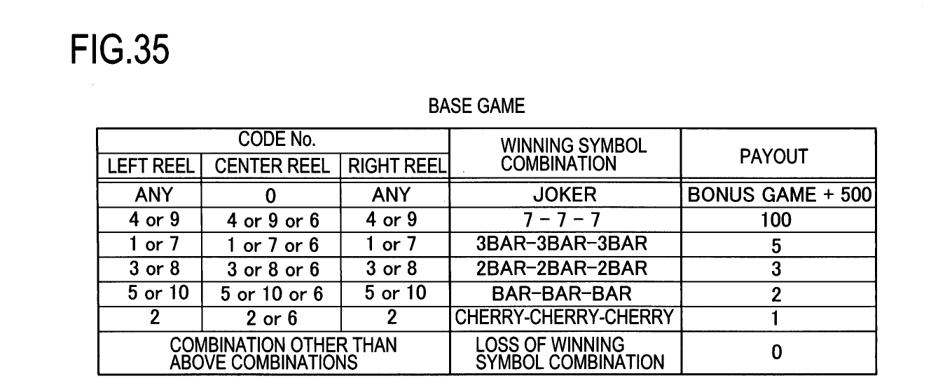

Next, in a case that the base game is conducted by utilizing three reels 520 in the slot machine 1, the winning symbol combinations and payouts will be described with reference to FIG. 35. FIG. 35 is an explanatory view showing correspondence between winning symbol combinations and payouts when the base game is conducted while utilizing three reels. In FIG. 35, in a case that the code number of the center reel is “0” (zero) and the code numbers of the right reel and the left reel is any of “1” to “10”, the bonus game is won. In this case, the trigger symbol 397 of the center reel is stopped and displayed on the pay line L in the variable display portion 323 and the payout thereof is 500 coins, thereby game condition shifts to the bonus game from the base game. Here, the bonus game is the game which is conducted after the base game is finished and the bonus game is generally made beneficial for the player in many cases.

And if the code numbers of the right reel and the left reel are “4” or “9” and the code number of the center reel is “4” or “9” or “6”, the winning symbol combination “7-7-7” is won. In this case, the symbol seven 394 of each of the reels is stopped and displayed on the pay line L in each of the variable display portions 322, 323 and 324, and the payout thereof is 100 coins. And if the code numbers of the right reel and the left reel are “1” or “7” and the code number of the center reel is “1” or “7” or “6”, the winning symbol combination “3BAR-3BAR-3BAR” is won. In this case, the 3BAR 391 of each of the reels is stopped and displayed on the pay line L in each of the variable display portions 322, 323 and 324, and the payout thereof is 5 coins. And if the code numbers of the right reel and the left reel are “3” or “8” and the code number of the center reel is “3” or “8” or “6”, the winning symbol combination “2BAR-2BAR-2BAR” is won. In this case, the 2BAR 393 is stopped and displayed on the pay line L in each of the variable display portions 322, 323 and 324, and the payout thereof is 3 coins. And if the code numbers of the right reel and the left reel are “5” or “10” and the code number of the center reel is “5” or “10” or “6”, the winning symbol combination “1BAR-1BAR-1BAR” is won. In this case, the 1BAR 395 is stopped and displayed on the pay line L in each of the variable display portions 322, 323 and 324, and the payout thereof is 2 coins. And if the code numbers of the right reel and the left reel are “2” and the code number of the center reel is “2” or “6”, the winning symbol combination “cherry-cherry-cherry” is won. In this case, the cherry 392 is stopped and displayed on the pay line L in each of the variable display portions 322, 323 and 324, and the payout thereof is 1 coin.

Here, the wild symbol 401 is the almighty symbol which can be substituted for any of the triple BAR 391, the cherry 392, the double BAR 393, the symbol seven 394, the single BAR 395 and the blank 396. Therefore, if the code number of the center reel is “6” and the code numbers of both the right reel and left reel correspond to any of the above mentioned numbers, any of the winning symbol combinations “7-7-7”, “3BAR-3BAR-3BAR”, “2BAR-2BAR-2BAR”, “1BAR-1BAR-1BAR” and “cherry-cherry-cherry” is won.

Here, if the combination of the code numbers in the right reel, the center reel and the left reel is a combination other than the above combinations, the winning symbol combination is lost. In this case, although any one of the triple BAR 391, the cherry 392, the double BAR 393, the symbol seven 394, the single BAR 395 and the blank 396, each of which corresponds to each code number, is stopped and displayed on the pay line L in each of the variable display portions 322, 323 and 324, the payout thereof is nothing.

In addition to the above, in a case that the bonus game is conducted in the slot machine 301, the lottery table utilized to determine the symbols stopped and displayed on the pay line L will be described with reference to FIG. 36. Here, the bonus game is conducted by utilizing the symbol columns 441 to 443 variably displayed on the variable display portions 322, 323 and 324 which are made opaque while being scrolled scrolling thereon. FIG. 36 is an explanatory view showing lottery tables of the stop display symbols when the bonus game is conducted through three variable display portions 322, 323 and 324.

The symbol stopped and displayed on the pay line L is determined every each of the variable display portions 322, 323, 324. In order to realize this, one of the code numbers “0”˜“3” is allotted to each symbol in the symbol columns 441 to 443 shown in FIG. 33, and it is provided the lottery table shown in FIG. 36. Further, three random number values are sampled corresponding to each of three reels which are hypothetically scrolled and displayed on the variable display portions 322, 323, 324, through the random number sampling circuit 356.

Here, in FIG. 36, for explanatory convenience, the hypothetical reel scrolled and displayed on the opaque left variable display portion 322 is described as the left reel, the hypothetical reel scrolled and displayed on the opaque right variable display portion 324 is described as the right reel and the hypothetical reel scrolled and displayed on the opaque center variable display portion 323 is described as the center reel.

As for the “left reel” with the symbol column 441 if the random number value sampled by the random number sampling circuit 356 lies in a range of 0˜31, the seven symbol 491 allotted to the code number “0” is stopped and displayed on the pay line L. And if the random number value lies in a range of 32˜63, the seven symbol 491 allotted to the code number “1” is stopped and displayed on the pay line L, and if the random number value lies in a range of 64˜95, the seven symbol 491 allotted to the code number “2” is stopped and displayed on the pay line L. If the random number value lies in a range of 96˜127, the seven symbol 491 allotted to the code number “3” is stopped and displayed on the pay line L.

And as for the center reel with the symbol column 442, if the random number value sampled by the random number sampling circuit 356 lies in a range of 0˜15, the seven symbol 491 allotted to the code number “0” is stopped and displayed on the pay line L. And if the random number value lies in a range of 16˜63, the blank 494 allotted to the code number “1” is stopped and displayed on the pay line L, and if the random number value lies in a range of 64˜79, the seven symbol 491 allotted to the code number “2” is stopped and displayed on the pay line L. If the random number value lies in a range of 80˜127, the blank 494 allotted to the code number “3” is stopped and displayed on the pay line L.

And as for the right reel with the symbol column 443, if the random number value sampled by the random number sampling circuit 356 lies in a range of 0˜12, the triple symbol 492 allotted to the code number “0” is stopped and displayed on the pay line L. And if the random number value lies in a range of 13˜47, the double symbol 493 allotted to the code number “1” is stopped and displayed on the pay line L, and if the random number value lies in a range of 48˜85, the seven symbol 491 allotted to the code number “2” is stopped and displayed on the pay line L. If the random number value lies in a range of 86˜127, the blank 494 allotted to the code number “3” is stopped and displayed on the pay line L.

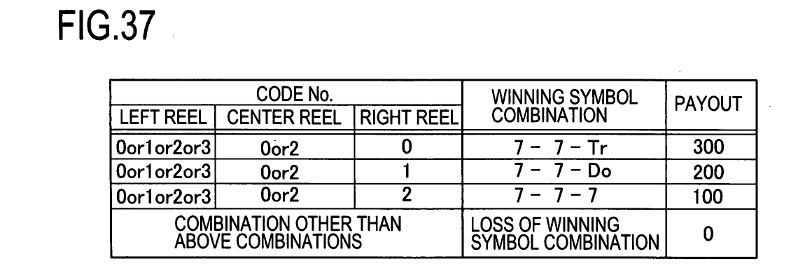

Next, the winning symbol combinations and the payouts utilized when the bonus game is conducted while utilizing three variable display portions 322, 323, 324 will be described with reference to FIG. 37. FIG. 37 is an explanatory view showing correspondence between winning symbol combinations and payouts when the bonus game is conducted while utilizing three variable display portions. In FIG. 37, if the code number of the left reel is any one of “0”˜“3” and the code number of the center reel is “0” or “2” and the code number of the right reel is “0”, the winning symbol combination “7-7-Tr” is won. In this case, the seven symbol 491, the seven symbol 491 and the triple symbol 492 are stopped and displayed on the pay line L through the variable display portions 322 to 324, and the payout thereof is 300 coins. And if the code number of the left reel is any one of “0”˜“3” and the code number of the center reel is “0” or “2” and the code number of the right reel is “1”, the winning symbol combination “7-7-Do” is won. In this case, the seven symbol 491, the seven symbol 491 and the double symbol 493 are stopped and displayed on the pay line L through the variable display portions 322 to 324, and the payout thereof is 200 coins. And if the code number of the left reel is any one of “0”˜“3” and the code number of the center reel is “0” or “2” and the code number of the right reel is “2”, the winning symbol combination “7-7-7” is won. In this case, the seven symbol 491, the seven symbol 491 and the seven symbol 491 are stopped and displayed on the pay line L through the variable display portions 322 to 324, and the payout thereof is 100 coins.

Here, if the combination of the code numbers in the left reel, the center reel and the right reel is a combination other than the above combinations, the winning symbol combination is lost. In this case, although any one of the seven symbol 491, the triple symbol 492, the double symbol 493 and the blank 494, each of which corresponds to each code number, is stopped and displayed on the pay line L in each of the variable display portions 322, 323, 324, the payout thereof is nothing.

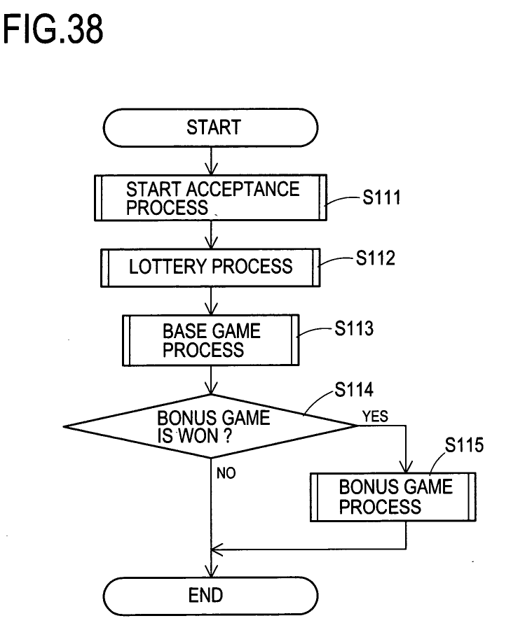

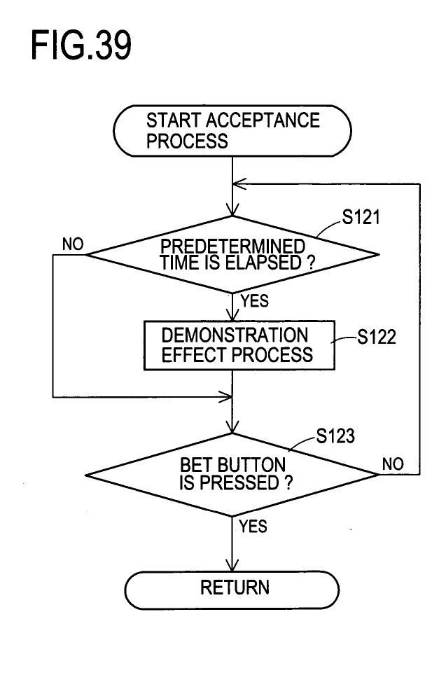

In addition to the above, the main process program executed in the slot machine 301 will be described with reference to FIG. 38. FIG. 38 is a flowchart of the main process program. In FIG. 38, at first, in step (abbreviated as “S” hereinafter) 111, start acceptance process in FIG. 39 mentioned later is executed. This start acceptance process is the process to accept the switch signal output from the spin switch 58, the 1-BET switch 59, the 3-BET switch 60 or the 5-BET switch 61, based on operation of the SPIN/REPEAT BET button 12, the 1-BET button 11, the 3-BET button or the 5-BET button 14. At the time that the switch signal output from each switch is accepted, the game is started.

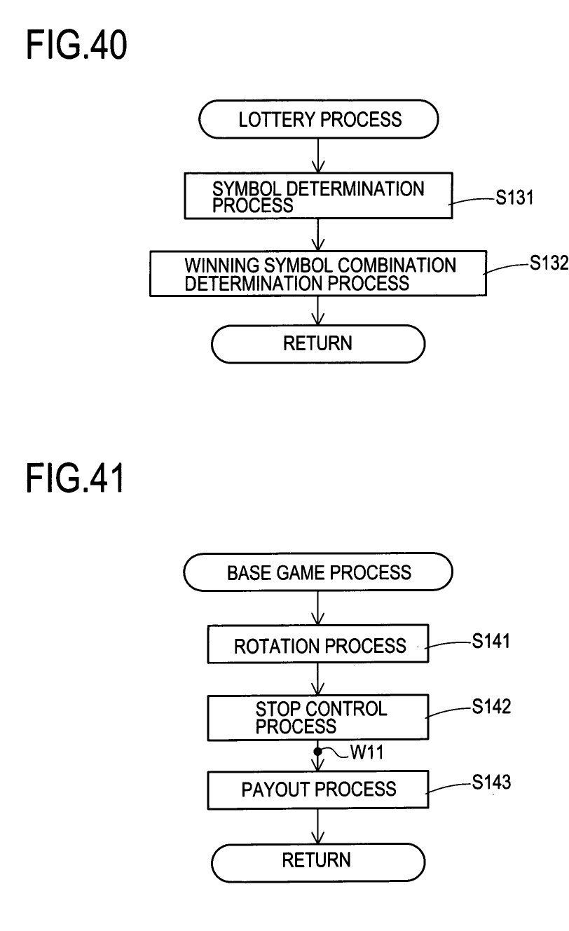

And in S112, the lottery process in FIG. 40 mentioned later is executed based on the switch signal output from the spin switch 58, the 1-BET switch 59, the 3-BET switch 60 or the 5-BET switch 61.

Here, if the bonus game is won, the number of times that the bonus games are continuously executed is determined, and such number of times is selected, for example, among 10˜25 games by the lottery.

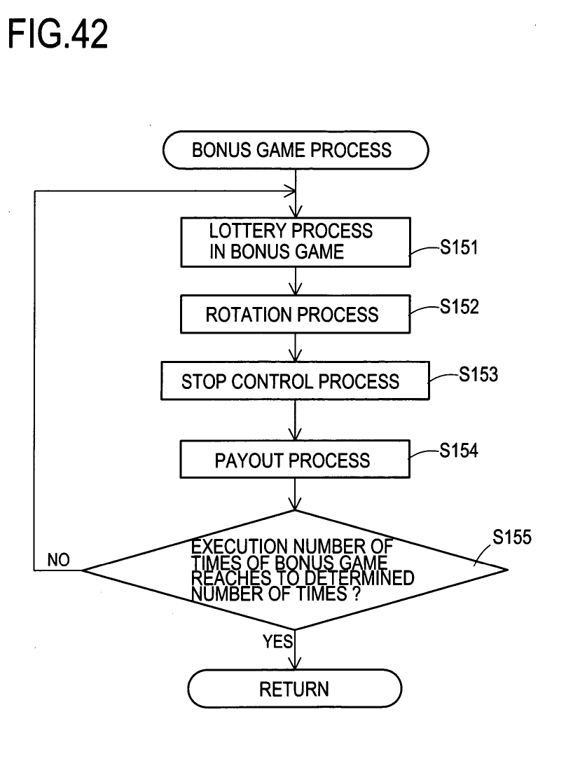

In S113, the base game process shown in FIG. 41 is executed. Thereafter, procedure shifts to S114 and it is determined whether the bonus game is won or not. Concretely speaking, in the lottery process in S112, if the trigger symbol 397 is stopped and displayed on the pay line L of the center variable display portion 323, the bonus game is triggered (S114: YES), therefore procedure shifts to S115 and the bonus game process in FIG. 42 is executed, thereafter the main process program is finished. On the other hand, if the trigger symbol 397 is not stopped and displayed on the pay line of the center variable display portion 323, the bonus game not triggered (S114: NO), therefore the main process program is finished.

Next, the start acceptance process program executed in the slot machine 301 will be with reference to FIG. 39. FIG. 39 is a flowchart showing a start acceptance process program. In S111 of the main process program shown in FIG. 38, the start acceptance process is executed. Concretely, at first, in S121 in FIG. 39, it is determined whether a predetermined time (for example, 15 seconds) is elapsed or not. Here, if it is determined that the predetermined time is not elapsed (S121: NO), procedure directly shifts to S123. On the other hand, if it is determined that the predetermined time is elapsed (S121: YES), the demonstration effect is conducted on the upper liquid crystal display 303 or the lower liquid crystal display 304 in S122, thereafter procedure shifts to S123. And in S123, it is determined whether or not the SPIN/REPEAT BET button 312, the 1-BET button 311, the 3-BET button 313 or the 5-BET button 314 is operated. Here, if it is determined that the 1-BET button 311 or the above buttons are not operated (S123: NO), procedure returns to S121 and the above processes are repeated. On the other hand, if it is determined that the 1-BET button 311 or the above buttons are operated (S123: YES), procedure returns to the main process program in FIG. 38 even while the demonstration effect is conducted, and procedure shifts to the lottery process in S112.

Next, the lottery process program conducted in the slot machine 301 will be described with reference to FIG. 40. FIG. 40 is a flowchart showing a lottery process program. In S112 of the main process program in FIG. 38, the lottery process is executed. Concretely, at first, in S131 in FIG. 40, the symbol determination process is executed. Here, the symbols (symbols formed on each of the reels 520) stopped and displayed on the pay line L in the base game are determined every each of three reels 520. Concretely, as mentioned above, three random number values are sampled by the random number sampling circuit 356 corresponding to each of the reels 520, and the stop display symbols are determined on the basis of the lottery tables in FIG. 34, by utilizing the code numbers. And if the symbols (symbols formed on each of the reels 520) stopped and displayed on the pay line L are determined, the winning symbol combination determining process is executed in S132, thereafter procedure returns to the main process program in FIG. 38 and shifts to the base game process. Here, in the winning symbol combination determining process, concretely speaking, the winning symbol combination and the payout are determined on the basis of the table in FIG. 35 by utilizing the code numbers obtained in S131.

Next, the base game process program conducted in the slot machine 301 will be described with reference to FIG. 41. FIG. 41 is a flowchart showing a base game process program. In S113 of the main process program in FIG. 38, the base game process is executed. Concretely, in S141 in FIG. 41, at first, three reels 520 are started to rotate and each of the symbol columns 541 to 543 on the reels 520 is scrolled and displayed through the transmissive variable display portions 322 to 324, based on the switch signal output from the spin switch 58, the 1-BET switch 59, the 3-BET switch 60 or the 5-BET switch 61.

And in S142, rotation of three reels 520 is automatically stopped, thereby scroll display of the symbol columns 541 to 543, which is done through the transmissive variable display portions 322 to 324, is terminated.

Therefore, when the CPU 350 executes procedures in S141 and S142 in the base game process program of FIG. 41, the CPU 350 functions as a reel control device.

And in S143, coins are paid out corresponding to the payout set beforehand based on the table in FIG. 35, according to the symbol combination (symbol combination of the symbols formed on the reels 520) of the winning symbol combination which is stopped and displayed through the transmissive variable display portions 322 to 324 in S142. Here, after the process in S143, procedure returns to the main process program and shifts to S114.

That is to say, when the base game is conducted in the slot machine 301, each of the variable display portions 322 to 324 of the lower liquid crystal display 304 are made transmissive except for a case mentioned later, and the symbol columns 541 to 543 formed on three reels 520 in the cabinet 302 can be seen through the transmissive variable display portions 322 to 324.

Next, the bonus game process program conducted in the slot machine 301 will be described with reference to FIG. 42. FIG. 42 is a flowchart showing a bonus game process program. In S114 of the main process program in FIG. 38, if it is determined that the bonus game is realized (S114: YES), procedure shifts to S115 of FIG. 38 and the bonus game process is conducted. In order to realize this, at first, procedure shifts to S151 in FIG. 42 and the lottery process during the bonus game is executed. Here, in the bonus game, the symbol stopped and displayed on the pay line L through the variable display portions 322 to 324 is determined every each of the variable display portions 322 to 324. Concretely, as mentioned above, three random number values corresponding the variable display portions 322 to 324 are sampled by the random number sampling circuit 356 at the timing that procedure shifts to S151 and the symbols to be stopped and displayed are determined on the basis of the lottery tables in FIG. 36, by utilizing the code numbers.

Next, in S152, scroll display of the symbol columns in the opaque variable display portions 322 to 324 is automatically started, thereafter in S153, scroll display of the symbol columns in the opaque variable display portions 322 to 324 is automatically stopped.

Here, at that time, scroll display and stop display of the symbol columns is done in the opaque variable display portions, therefore three reels 520 in the cabinet 302 cannot be seen through the opaque variable display portions 322 to 324.

And in the payout process in S154, the credit corresponding to the payout determined based on the table in FIG. 37 is paid out, according to the symbol combination corresponding to the winning symbol combination, the symbol combination being stopped and displayed on each of the variable display portions in S153.

Next, procedure shifts to S155 and it is determined whether the number of times of the bonus games which are executed reaches to the number of times of the bonus games determined in S112 in FIG. 38 or not. At that time, if it is determined that the number of times of the bonus games which are executed does not reach to the number of times of the bonus games determined in S112 in FIG. 38 (S155: NO), procedure returns to S151 and the above processes are repeated. On the other hand, if it is determined that the number of times of the bonus games reaches to the number of times determined S112 (S155: YES), the bonus game process is finished.

Here, if the bonus game is won in S151, the repeat number of times of the bonus game is determined again and the determined repeat number of times is added to the “number of times determined in S112 of FIG. 38” used in the determination process in S155. Thereby, when the bonus game is won during the bonus game, procedure can again shift to the bonus game. Concretely speaking, for example, in a case that procedure shifts to the bonus game with 20 number of times for the first time and the bonus game with 17 number of times is won in the twelfth bonus game, the bonus games are conducted in 25 times (20 times−12 times+17 times) thereafter.

As mentioned, the CPU 350 functions as a game control device when the main process program of FIG. 38 is executed.

By the way, in the base game conducted in the slot machine 301 according to the second embodiment, in a case that the wild symbol 401 is stopped and displayed on the pay line L of the variable display portions 323 when the symbols (symbols formed on each of the reels 520) are stopped and displayed through the transmissive variable display portions 322 to 324, the wild symbol 401 on the pay line L can be regarded as any of the triple BAR 395, the cherry 392, the double BAR 393, the symbol seven 394, the single BAR 395 and the blank 396. Thereby, it is determined whether or not any of the winning symbol combinations (except for the joker symbol) shown in the table of FIG. 35 is realized. At that time, if it is determined that any of the winning symbol combinations shown in the table of FIG. 35 is realized, the area of variable display portion 323 superimposed with the wild symbol 401 on the pay line L is made opaque, thereby the wild symbol 401 cannot be seen. Further, the symbol to realize the winning symbol combination is displayed on the opaque variable display portion 323.

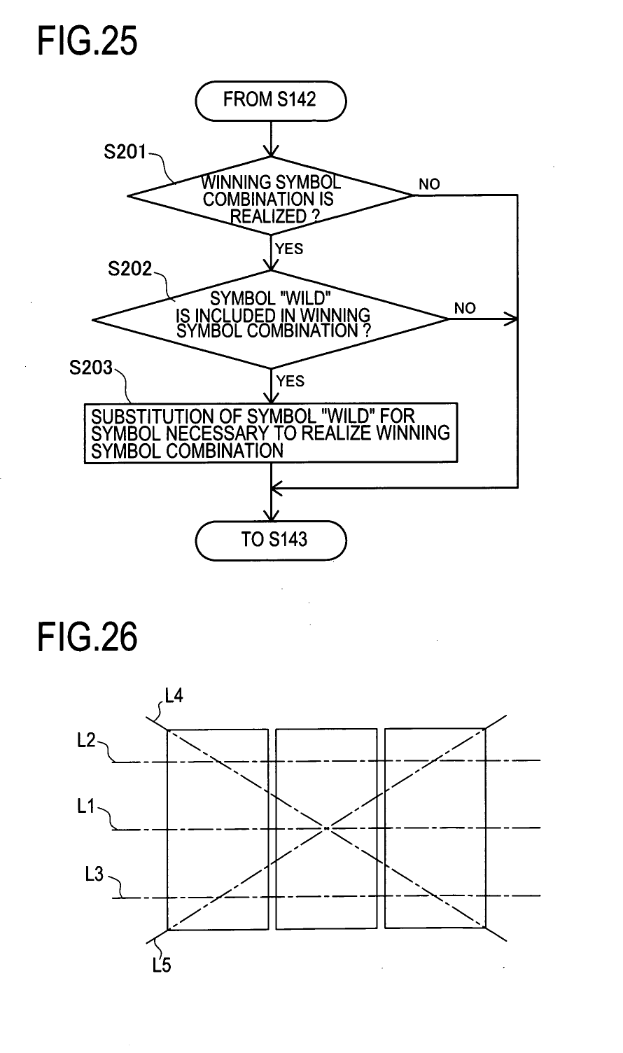

In order to realize the above, for example, the process shown in FIG. 25 is conducted at the timing W11 right after the stop control process in S142 in the base game program process of FIG. 41 is executed. That is to say, in the base game process program of FIG. 41, after the stop control process in S142 is executed, procedure shifts to S201 in FIG. 25 and it is determined whether or not the winning symbol combination is realized in the symbol combination on the pay line L. When this determination is conducted, the wild symbol 401 is regarded as any of the triple BAR 395, the cherry 392, the double BAR 393, the symbol seven 394, the single BAR 395 and the blank 396.

At that time, if it is determined that the winning symbol combination is not realized in the symbol combination on the pay line L (S201: NO), procedure returns to the base game process program in FIG. 41 and shifts to the payout process in S143. On the other hand, if it is determined that the winning symbol combination is realized in the symbol combination on the pay line L (S201: YES), procedure shifts to S202.

Here, in determination of S201, a determination result in the winning symbol combination determination process of S132 in the lottery process of FIG. 40 may be utilized.

And in S202, it is determined whether or not the wild symbol is included in the symbol combination on the pay line L in which the winning symbol combination is realized. At that time, if it is determined that the wild symbol 401 is not included in the symbol combination on the pay line L in which the winning symbol combination is realized (S202: NO), procedure returns to the base game process program in FIG. 41 and shifts to the payout process in S143. On the other hand, if it is determined that the wild symbol is included in the symbol combination on the pay line L in which the winning symbol combination is realized (S202: YES), procedure shifts to S203.

And in S203, it is instructed to the image control CPU 83 to substitute the wild symbol 401 on the pay line L for the symbol by which the winning symbol combination is realized and to display it.

Concretely speaking, for example, as shown in the uppermost display example of FIG. 23, if the symbols (symbols formed on each of the reels 520) are stopped and displayed through the transmissive variable display portions 322 to 324, the wild symbol 401 is regarded as the symbol seven 394, thereby the winning symbol combination “7-7-7” is realized on the pay line L. However, at that time, as shown in the medium display example of FIG. 23, the symbol seven 394 is displayed while the area 402 in the variable display portion 323 superimposed with the wild symbol 401 which is stopped and displayed on the variable display portion 323 is made opaque. Thereby, the wild symbol 401 is substituted for the symbol seven 394 and the symbol seven 394 is displayed instead of the wild symbol 401. Therefore, in the substitution display state, the player cannot see and recognize the wild symbol 401. Further, thereafter, as shown in the lowermost display example of FIG. 23, the symbol seven 394 is erased while the area 402 of the variable display portion 323 is again made transmissive, thereby display state is returned to the symbols (symbols formed on each of the reels 520) when stopped and displayed.

Here, after process in S203 is executed, procedure shifts to the base game process program in FIG. 41 and payout process in S143 is conducted.

Therefore, the image control CPU 383 functions as a display control device when process in S203 of FIG. 25 is executed.

That is to say, in the slot machine 301 of the second embodiment, in a case that the wild symbol 401 is included in the symbol combination stopped and displayed through the transmissive variable display portions 322 to 324 of the lower liquid crystal display 304 and any of the winning symbol combinations shown in table in FIG. 35 is realized in the symbol combination obtained by substituting the wild symbol for any of the triple BAR 391, the cherry 392, the double BAR 393, the symbol seven 394, the single BAR 395 and the blank 396 (S201: YES, S202: YES), such symbol combination is displayed on the variable display portions 322 to 324 of the lower liquid crystal display 304 in a substitution state that the wild symbol 401 is substituted for any of the triple BAR 391, the cherry 392, the double BAR 393, the symbol seven 394, the single BAR 395 and the blank 396 (S203).

Explaining the above point in the mentioned example, as shown in the uppermost display example of FIG. 23, if the symbols (symbols formed on each of the reels 520) are stopped and displayed through the transmissive variable display portions 322 to 324, the wild symbol is regarded as the symbol seven 394, thereby the winning symbol combination “7-7-7” is realized on the pay line L. At that time, as shown in the medium display example of FIG. 23, the symbol seven 394 is displayed while the area 402 of the variable display portion 323 superimposing with the wild symbol 401 stopped and displayed on the variable display portion 323 is made opaque. Thereby, the wild symbol 401 is substituted for the symbol seven 394 and the symbol seven 394 is displayed instead of the wild symbol 401. By this substitution and display, on the pay line L formed so as to across the center of each of the variable display portions 322 to 324, the winning symbol combination “7-7-7” is directly displayed thereon and the player cannot see and recognize the wild symbol 401. Therefore, as shown in the uppermost display example of FIG. 23, after the symbols (symbols formed on each of the reels 520) are stopped and displayed, the player can continuously recognize the winning symbol combination at sight.

Here, the present invention is not limited to the above embodiments and various changes and modifications can be done within the scope of the present invention.

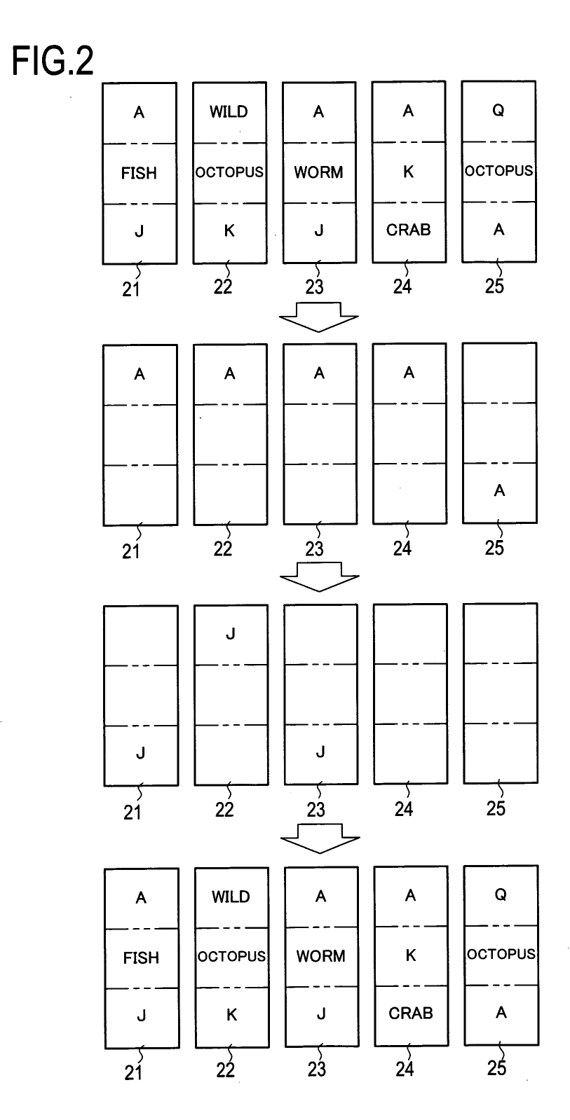

For example, in the slot machine 1 of the first embodiment, as mentioned, for sake of explanation convenience, supposed that all of twenty-five pay lines are activated, in a case that the symbols are stopped an displayed on each of the variable display portions 21 to 25 as shown in FIG. 4, the substitution display shown in FIG. 1 is conducted by executing process in S103 of FIG. 7. At this point, substitution and display shown in FIG. 2 may be conducted. That is, when the symbols are stopped and displayed, each of the variable display portions 21 to 25 are made in a state shown in the uppermost display example in FIG. 2. However, thereafter, as shown in the second display example in FIG. 2, instead of the symbol “WILD” stopped and displayed in the first stop display area 221 (see FIG. 15) of the variable display portion 22, the symbol “A” is displayed and at the same time the symbols other than the winning symbol combination according to the symbol “A” displayed are erased. Thereby, only the winning symbol combination, in which five symbols “A” continuously appear from the left end of the pay line L and which is realized on the pay line constructed from the first stop display areas 211, 221, 231, 241 and the third stop display area 253, is directly displayed, thereby the player can recognize the winning symbol combination at sight. Further, thereafter, as shown in the third display example of FIG. 2, in stead of the symbol “A” displayed on the first stop display area 221 (see FIG. 15) of the variable display portion 22, the symbol “J” is displayed and at the same time the symbols constructing the winning symbol combination which is realized by the symbol “J” is again displayed and the symbols other than the symbols not concerning with the winning symbol combination which is realized by the symbol “J” are erased. Thereby, only the winning symbol combination, in which three symbols “J” continuously appear from the left end of the pay line L and which is realized on the pay line constructed from the first stop display areas 221 and the third stop display areas 213, 233, 243, 253, is directly displayed, thereby the player can recognize the winning symbol combination at sight. Thereafter, as shown in the lowermost display example of FIG. 2, instead of the symbol “J” displayed on the first stop display area 221 (see FIG. 15) of the variable display portion 22, the symbols “WILD” is displayed and at the same time the symbol which is erased is again displayed. Thereby, the display state returns to the state when the symbols are stopped and displayed.

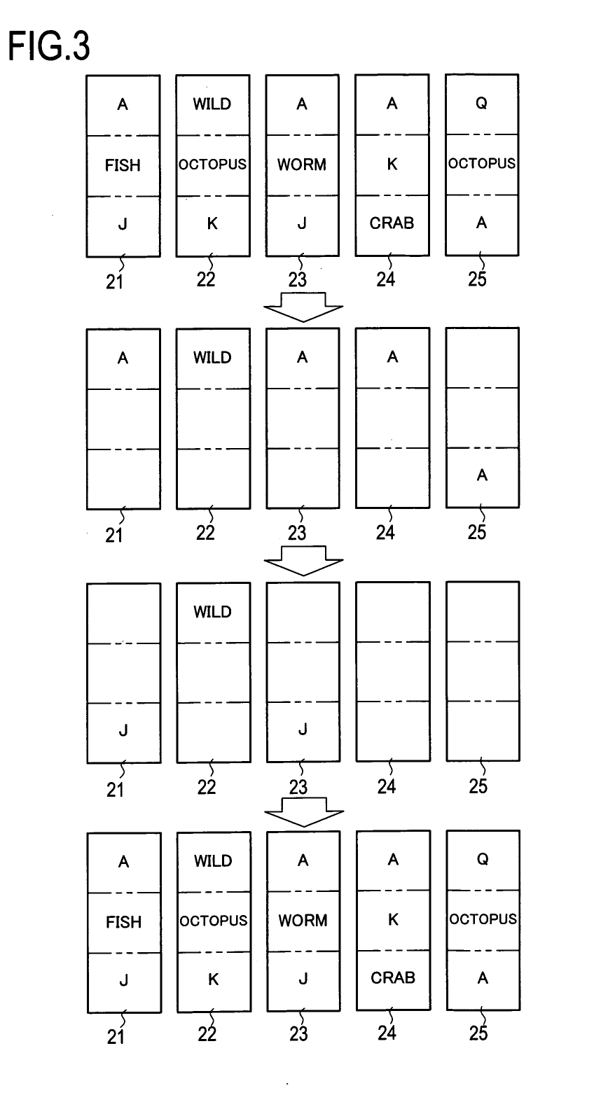

And as shown in the second display example and the third display example of FIG. 3, even if the symbol “WILD” is not substituted, the player can recognize the winning symbol combination at sight by deleting the symbols other than the symbols constructing the winning symbol combination.

Further, in the slot machine 1 of the first embodiment, the symbol stopped and displayed on the pay line constructed from the second stop display areas 212, 222, 232, 242, 252 is determined every each of the variable display portions 21 to 25 in the base game and the bonus game, based on the lottery table in FIG. 14 in which one random number value sampled through the random number sampling circuit 56 and one code No. are corresponded with each other. As for this point, for example, the symbol stopped and displayed on the pay line constructed from the second stop display areas 212, 222, 232, 242, 252 may be determined every each of the variable display portions 21 to 25, based on the lottery table in FIG. 21 in which a specific range of the random numbers sampled through the random number sampling circuit 56 corresponds to one code No.

Further, although the slot machine 1 of the first embodiment conducts the video slot game through five reels, it may be conducted the video slot game through three reels or nine reels.

And in the slot machine 1 of the first embodiment, although it is described the example that one symbol “WILD” is included in the winning symbol combination which is realized on one pay line, a plurality of symbols “WILD” may be included in the winning symbol combination which is realized on one pay line.

Further, in the slot machine 1 of the first embodiment, although it is described the example that the symbol “WILD” is included in the winning symbol combination which is realized on two pay lines, the pay line on which the winning symbol combination is realized in a state that the symbol “WILD” is included may be only one or more than three.

And in the slot machine 301 of the second embodiment, it is described that example that one wild symbol 401 is included in the winning symbol combination which is realized on one pay line L, a plurality of wild symbols 401 may be included in the winning symbol combination which is realized on one pay line L.

Further, although the pay line L in the slot machine 301 of the second embodiment is set to one center line formed so as to cross the center of each of the variable display portions 322 to 324, five pay lines of the center line L1, the top line L2, the bottom line L3, the cross-down line L4 and the cross-up line L5 may be provided and the CPU 350 may respectively activate five pay lines according to insertion amount of coins.

Further, in a case that the wild symbol 401 is included in the symbol combination (symbol combination of the symbols formed on each of the reels 520) stopped and displayed on the pay line (s) which is/are activated among five pay lines L1 to L5, the wild symbol 401 is substituted for any of the triple BAR 391, the cherry 392, the double BAR 393, the symbol seven 394, the single BAR 395 and the blank 396. Thereby, if any of the winning symbol combinations shown in the table of FIG. 35 is realized based on such symbol combination in which the wild symbol 401 is substituted (S201: YES, S202: YES), the winning symbol combination is displayed on the variable display portions 322 to 324 of the lower liquid crystal display 304 while retaining the state that the wild symbol 401 is substituted for any of the triple BAR 391, the cherry 392, the double BAR 393, the symbol seven 394, the single BAR 395 and the blank 396 (S203).

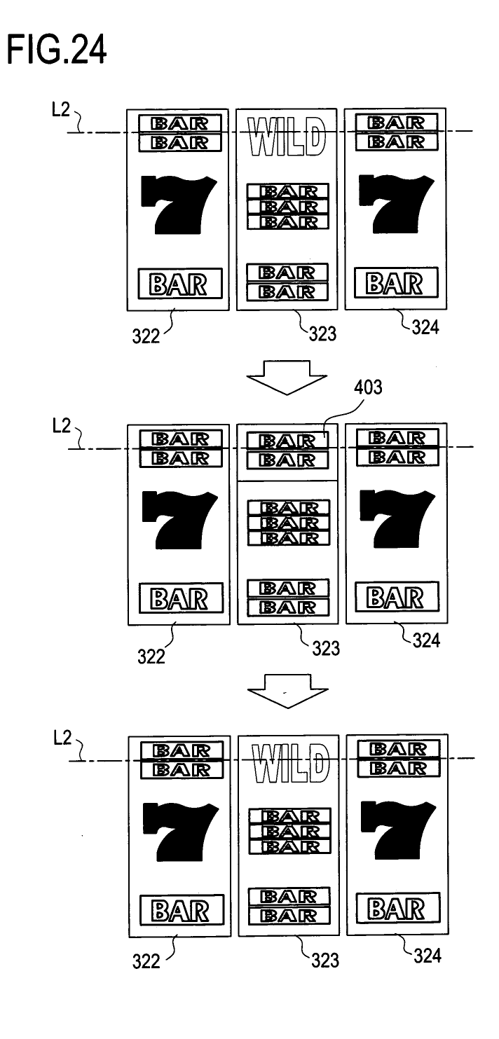

Explaining the above point in the mentioned example, if the top line L2 is, for example, activated, as shown in the uppermost display example of FIG. 24, if the symbols (symbols formed on each of the reels 520) are stopped and displayed through the transmissive variable display portions 322 to 324, the wild symbol 401 is regarded as the double BAR 393, thereby the winning symbol combination “2BAR-2BAR-2BAR” is realized on the top line L2. At that time, as shown in the medium display example of FIG. 24, the double BAR 393 is displayed while the area 403 of the variable display portion 323 superimposing with the wild symbol 401 stopped and displayed on the variable display portion 323 is made opaque. Thereby, the wild symbol 401 is substituted for the double BAR 393 and the double BAR 393 is displayed instead of the wild symbol 401. By this substitution and display, on the top line L2 formed so as to across the upper portion of each of the variable display portions 322 to 324, the winning symbol combination “2BAR-2BAR-2BAR” is directly displayed thereon and the player cannot see and recognize the wild symbol 401. Therefore, as shown in the uppermost display example of FIG. 24, after the symbols (symbols formed on each of the reels 520) are stopped and displayed on the variable display portions 322 to 324, the player can continuously recognize the winning symbol combination at sight. Further, thereafter, as shown in the lowermost display example of FIG. 24, the double BAR 393 is erased while the area 403 of the variable display portion 323 is returned the transmissive state, thereby display state is returned to the symbols (symbols formed on each of the reels 520) when stopped and displayed.

That is to say, in the slot machine 301 of the second embodiment, although only one center line is handled as the pay line, a plurality of pay lines may be provided. In this case, substitution and display may be conducted on plural pay lines. At that time, based on that the wild symbol 401 is stopped and displayed on intersections that a plurality of pay lines are crossed with each other, if a plurality of winning symbol combinations are realized and a plurality of symbols to realize the winning symbol combinations exist, the image control CPU 383 conducts display control to successively substitute the wild symbol for the symbols.

And in substitution and display done in the slot machine 301 of the second embodiment, for example, as shown in the medium display example of FIG. 23, the symbol seven 394 is displayed in the area 402 of the variable display portion 323 while the area 402 of the variable display portion 323 superimposing with the wild symbol 401 which is stopped and displayed through the variable display portion 323 is made opaque, thereby the wild symbol 401 cannot be perfectly seen and recognized. At this point, while retaining the transmissive state of the area 402 of the variable display portion 323, the symbol seven 394 may be displayed on the area 402 of the variable display portion 323 and the symbol seven 394 may be displayed so as to superimpose with the wild symbol 401 (wild symbol formed on the reel 520) which is stopped and displayed on the variable display portion 323. Thereby, it may be realized a state that the wild symbol 401 is shuttered by the symbol seven 394, as a result, the wild symbol 401 can be scarcely seen and recognized.

And in the slot machine 301 of the second embodiment, although the base game is executed with three reels, the base game may be executed with five reels.

Further, in the slot machine 301 of the second embodiment, although the bonus game is conducted on the lower liquid crystal display 304 and the base game is conducted through the reels 520, the base game may be conducted on the lower liquid crystal display 304 and the bonus game may be conducted through the reels 520 and the above substitution and display may be done in the bonus game.

The present invention can be applied to a case that the game is executed by using symbols displayed on the display device.

And the present invention can be applied to a case that games are executed while seeing and recognizing the symbols of the reels through the display device in which the transmissive state can be formed.

What is claimed is:

1. A gaming machine comprising:
a display device for displaying plural kinds of symbols including a wild symbol which is substitutable for one of the symbols;
a first determination device for determining whether or not a symbol combination constructed from the symbols stopped on the display device corresponds to a predetermined winning symbol combination while regarding the wild symbol as one of the symbols;
a second determination device for determining whether or not the wild symbol is included in the symbol combination if it is determined by the first determination device that the symbol combination corresponds to the predetermined winning symbol combination; and
a display control device for controlling the display device so as to display the symbol combination corresponding to the predetermined winning symbol combination while substituting the wild symbol for one of the symbols if it is determined by the second determination device that the wild symbol is included in the symbol combination.

2. The gaming machine according to claim 1, wherein the first determination device determines whether or not a plurality of the symbol combinations each of which is constructed from the symbols stopped on the display device correspond to a plurality of the winning symbol combinations, and
wherein the display control device controls the display device so as to reciprocally display each of the winning symbol combinations while substituting the wild symbol for one of the symbols if it is determined by the first determination device that each of the symbol combinations corresponds to each of the winning symbol combinations.

3. The gaming machine according to claim 1, wherein the display control device controls the display device so as to display only the symbols constructing the winning symbol combination while substituting the wild symbol for one of the symbols.

4. A gaming machine comprising:
a plurality of reels having plural kinds of symbols thereon, at least one reel having a wild symbol which is able to be regarded as one of the symbols included in the symbols;
a display device arranged in front of the reels, the display device having a plurality of display windows each of which is able to become a transmissive state that the symbols of the reels are seen therethrough and an opaque state that the symbols are displayed thereon;
a first determination device for determining whether or not a symbol combination constructed from the symbols stopped within each of the display windows corresponds to a predetermined winning symbol combination while regarding the wild symbol as one of the symbols;
a second determination device for determining whether or not the wild symbol is included in the symbol combination if it is determined by the first determination device that the symbol combination corresponds to the predetermined winning symbol combination; and
a display control device for controlling the display device to display the symbol in the display window so that the symbol covers the wild symbol in the opaque state and the symbol combination corresponds to the predetermined winning symbol combination if it is determined by the second determination device that the wild symbol is included in the symbol combination.

5. The gaming machine according to claim 4, wherein the first determination device determines whether or not the symbol combination constructed from the symbols stopped within each of the display windows corresponds to the predetermined winning symbol combination while regarding the wild symbol as one of the symbols.

6. The gaming machine according to claim 3, wherein the symbols other than the winning symbol combination are erased.
